(19) United States
(12) Patent Application Publication
(10) Pub. No.: US 2021/0409770 A1
(43) Pub. Date: Dec. 30, 2021

(54) IMAGE PROCESSING APPARATUS, IMAGE PROCESSING METHOD, AND PROGRAM

(71) Applicant: SONY CORPORATION, Tokyo (JP)

(72) Inventors: Yusuke MIYAGI, Kanagawa (JP); Yoshitaka MORIGAMI, Tokyo (JP)

(73) Assignee: SONY CORPORATION, Tokyo (JP)

(21) Appl. No.: 16/625,347

(22) PCT Filed: May 15, 2018
(86) PCT No.: PCT/JP2018/018722

§ 371 Date: Dec. 20, 2019

(30) Foreign Application Priority Data
Jun. 29, 2017 (JP) 2017-127220

(51) Int. Cl. H04N 19/61; H04N 19/124; H04N 19/82; H04N 19/18; H04N 19/176

(52) U.S. Cl. CPC H04N 19/61; H04N 19/124; H04N 19/176; H04N 19/18; H04N 19/82

(57) ABSTRACT

An image processing apparatus executes quantization of a plurality of types of coefficients for respective transform processing blocks for residual data that indicates a difference between original image data and predicted image data calculated by a computing part 12. For example, a transform coefficient produced by an orthogonal-transforming part 14 is quantized by a quantizing part 15 to produce transform quantized data, and the residual data is quantized by a quantizing part 16 by using transform skipping that skips orthogonal transform to produce transform-skipping quantized data. An entropy coding part 28 codes the transform quantized data and the transform-skipping quantized data to produce a coded stream. Degradation in image quality of a decoded image generated by using the transform skipping can be suppressed using the decoding result of the transform coefficient quantized data.

### TECHNICAL FIELD

The present technique relates to an image processing apparatus, an image processing method, and a program, and enables suppression of degradation in image quality of a decoded image.

### BACKGROUND ART

Such apparatuses have conventionally been widely used to efficiently transmit or record a moving image, as an encoding apparatus that executes coding for moving image data to produce a coded stream and a decoding apparatus that executes decoding for a coded stream to produce moving image data. Moreover, as a moving image coding scheme, as described in, for example, NPL 1 and NPL 2, HEVC (High Efficiency Video Coding, that is, ITU-T H.265 or ISO/IEC 23008-2) has been standardized.

In the HEVC, picture division is executed in units of block, called “CTU (Coding Tree Unit).” The CTU has a fixed block size of as many pixels as a multiple of 16 up to a maximum of 64×64 pixels. Each CTU is divided into coding units (CUs) each having a variable size on a quadtree basis. Moreover, in a case where the CTU is not divided, the CTU represents the CU. Each CU is divided into a block called “prediction unit (PU)” and a block called “transform unit (TU).” The PU and the TU are each independently defined in the CU. In the HEVC, a transform-skipping mode is provided in which a prediction error for TUs is quantized while its orthogonal transforms are skipped for retaining sharp edges.

Moreover, in PTL 1, skipping of orthogonal transform is selected on the basis of a feature amount that indicates the property of the prediction error.

### CITATION LIST

### Patent Literature

### [PTL 1]

Japanese Patent Laid-open No. 2014-131270

### Non Patent Literature

### [NPL 1]

ITU-T Recommendation H.265: “High efficiency video coding,” 2013.

### [NPL 2]

ISO/IEC 23008-2: “High Efficiency Video Coding,” 2013.

### SUMMARY

### Technical Problem

Concerning the above, in a case where residual data (a prediction error) includes a DC component (a direct current component), when orthogonal transform is skipped and the residual data is quantized, the DC component may be unable to be reproduced by the residual data after an inverse quantization. Moreover, when a DC shift is generated in the residual data by skipping orthogonal transform, discontinuity is generated in a block border portion between the TU for which the orthogonal transform is executed and the TU for which orthogonal transform is skipped, and the decoded image becomes an image with degraded image quality.

The present technique therefore provides an image processing apparatus, an image processing method, and a program that each can suppress degradation in image quality of a decoded image.

### Solution to Problem

A first aspect of the present technique is an image processing apparatus that includes:

a quantizing part quantizing a plurality of types of coefficients that is produced by respective transform processing blocks from image data, for each of the types, to produce quantized data; and

a coding part coding the quantized data of each of the plurality of types produced by the quantizing part, to produce a coded stream.

In the present technique, the quantizing part produces quantized data of each of, a plurality of types of coefficients produced by respective transform processing blocks such as, for example, a transform coefficient acquired by an orthogonal transform process, and a transform-skipping coefficient acquired by a transform-skipping process for the orthogonal transform to be skipped, from residual data that indicates a difference between the image data such as, for example, image data to be coded and predicted image data. The coding part codes the quantize data of the transform-skipping coefficient and the quantized data of the coefficient of, for example, the DC component (the direct current component) in the transform coefficient. Moreover, a filtering part executing a component separation process for the image data in a frequency region or a spatial region is disposed, and the coding part codes the quantized data of the transform coefficient acquired by executing an orthogonal transform for first separation data acquired by a component separation process by the filtering part, and the quantized data of the transform-skipping coefficient acquired by executing a transform skipping process for second separation data that is different from the first separation image data acquired by the component separation process.

Moreover, the coding part may code the quantized data of the transform coefficient acquired by executing the orthogonal transform for the image data, and the quantized data of the transform-skipping coefficient acquired by executing the transform-skipping process for the difference between the decoded data and the image data acquired by a quantization, an inverse quantization, and an inverse orthogonal transform of the coefficient data of the transform coefficient. Moreover, the coding part may code the quantized data of the transform-skipping coefficient acquired by executing the transform-skipping process for the image data, and the quantized data of the transform coefficient acquired by executing the orthogonal transform process for the difference between the decoded data and the image data acquired by executing a quantization and an inverse quantization for the coefficient data of the transform-skipping coefficient.

The quantizing part executes quantization of the coefficients on the basis of a quantized parameter set for each of the types of the coefficients, and the coding part codes information indicating a quantized parameter set for each of the types of the coefficients and includes the coded information in the coded stream.

A second aspect of the present technique is an image processing method that includes the steps of:

producing quantized data by quantizing a plurality of types of coefficients produced by respective transform processing blocks, for each of the types, from image data; and

producing a coded stream by coding the quantized data of each of the plurality of types produced by the quantizing part.

A third aspect of the present technique is a program causing a computer to execute an image processing process, the program causing the computer to execute:

a procedure of quantizing a plurality of types of coefficients produced by respective transform processing blocks from image data, for each of the types to produce quantized data; and

a procedure of coding the produced quantized data of each of the plurality of types to produce a coded stream.

A fourth aspect of the present technique is an image processing apparatus that includes:

a decoding part executing decoding for a coded stream to acquire quantized data of a plurality of types of coefficients, for each of the types;

an inverse-quantizing part executing inverse quantization for the quantized data acquired by the decoding part to produce each of the types of coefficients;

an inverse-transforming part producing image data for each of the types of the coefficients from the coefficients acquired by the inverse-quantizing part; and

a computing part executing a computation process using the image data of each of the types of the coefficients acquired by the inverse-transforming part to produce decoded image data.

In the present technique, decoding of the coded stream is executed by the decoding part to acquire, for example, the quantized data of the plurality of types of coefficients for each of the types and information indicating the quantization parameters of the plurality of types of coefficients for each of the types. The inverse-quantizing part executes inverse quantization for the quantized data acquired by the decoding part to produce the coefficient for each of the types. Moreover, in the inverse quantization, the inverse quantization is executed for the corresponding quantized data using the information regarding the corresponding quantized parameters for each of the types. The inverse-transforming part produces the image data for each of the types of the coefficients from the coefficients acquired by the inverse-quantizing part. The computing part executes the computation process using the image data of each of the types of the coefficients acquired by the inverse-transforming part, and adds the image data and the predicted image data to each other for each of the types of the coefficients acquired by the inverse-transforming part, aligning each pixel position, to produce the decoded image data.

A fifth aspect of the present technique is an image processing method that includes the steps of:

executing decoding for a coded stream to acquire quantized data of a plurality of types of coefficients, for each of the types;

executing inverse quantization of the acquired quantized data to produce each of the types of coefficients;

producing image data for each of the types of the coefficients from the produced coefficients; and

executing a computation process using the image data of each of the types of the coefficients to produce decoded image data.

A sixth aspect of the present technique is a program causing a computer to execute an image decoding process, the program causing the computer to execute:

a procedure of executing decoding of a coded stream to acquire quantized data of a plurality of types of coefficients, for each of the types;

a procedure of executing an inverse quantization of the acquired quantized data to produce each of the types of coefficients;

a procedure of producing image data for each of the types of the coefficients from the produced coefficient; and

a procedure of executing a computation process using the image data of each of the types of the coefficients to produce decoded image data.

Note that the program of the present technique is a program capable of being provided by a storage medium, a communication medium, a storage medium such as, for example, an optical disk, a magnetic disk, or a semiconductor memory that each provide the program in a computer-readable format, or by a communication medium such as a network to, for example, a general-purpose computer capable of executing various program codes. The processes in accordance with the program are realized on the computer by providing the program in the computer-readable format.

### Advantageous Effect of Invention

According to the present technique, the quantized data is produced by quantizing the plurality of types of coefficients produced by the respective transform processing blocks, for each of the types from the image data, the quantized data for each of the plurality of types is coded, and accordingly, the coded stream is produced. Moreover, decoding of the coded stream is executed, the quantized data of the plurality of types of coefficients for each of the types is acquired, and the inverse quantization of the acquired quantized data is executed to produce the coefficient of each of the types. Moreover, the image data is produced for each of the types of the coefficients from the produced coefficients, and the decoded image data is produced by the computation process that uses the image data of each of the types of the coefficients. Degradation in image quality of the decoded image can therefore be suppressed. Note that the effect described herein is merely exemplification and is not limited thereto and, moreover, additional effects may be achieved.

### BRIEF DESCRIPTION OF DRAWINGS

FIG. 1 is a diagram exemplifying a configuration of a first embodiment of an image coding apparatus.

FIG. 2 is a flowchart exemplifying operations of the first embodiment.

FIG. 3 is a diagram exemplifying a configuration of a second embodiment of the image coding apparatus.

FIG. 4 is a flowchart exemplifying operations of the second embodiment.

FIG. 5 is a diagram exemplifying a configuration of a third embodiment of the image coding apparatus.

FIG. 6 is a flowchart exemplifying operations of the third embodiment.

FIG. 7 is a diagram exemplifying a configuration of a fourth embodiment of the image coding apparatus.

FIG. 8 illustrate diagrams each exemplifying a configuration of a filtering part in a case where a component separation process is executed in a frequency region.

FIG. 9 illustrate diagrams each exemplifying another configuration of the filtering part in a case where the component separation process is executed in a spatial region.

FIG. 10 illustrate diagrams each exemplifying a spatial filter.

FIG. 11 is a flowchart exemplifying operations of the fourth embodiment.

FIG. 12 is a diagram exemplifying a configuration of a first embodiment of an image decoding apparatus.

FIG. 13 is a flowchart exemplifying operations of the first embodiment.

FIG. 14 is a diagram exemplifying a configuration of a second embodiment of the image decoding apparatus.

FIG. 15 is a flowchart exemplifying operations of the second embodiment.

FIG. 16 illustrate diagrams depicting exemplary operations.

FIG. 17 illustrate diagrams exemplifying original images and decoded images.

FIG. 18 is a diagram (Part I) depicting syntaxes relating to transmission of a plurality of types of coefficients.

FIG. 19 is a diagram (Part II) depicting syntaxes relating to the transmission of the plurality of types of coefficients.

FIG. 20 illustrate diagrams depicting syntaxes in a case where a plurality of quantization parameters is used.

FIG. 21 is a diagram depicting an example of a schematic configuration of a television apparatus.

FIG. 22 is a diagram depicting an example of a schematic configuration of a mobile phone.

FIG. 23 is a diagram depicting an example of a schematic configuration of a recording and reproducing apparatus.

FIG. 24 is a diagram depicting an example of a schematic configuration of an imaging apparatus.

### DESCRIPTION OF EMBODIMENTS

Modes to implement the present technique will be described below. In addition, a description will be made in the following order.

1. Overview of Image Processing Apparatus

2. Regarding Image Coding Apparatus
2-1. First Embodiment
   2-1-1. Configuration of Image Coding Apparatus
   2-1-2. Operations of Image Coding Apparatus
2-2. Second Embodiment
   2-2-1. Configuration of Image Coding Apparatus
   2-2-2. Operations of Image Coding Apparatus
2-3. Third Embodiment
   2-3-1. Configuration of Image Coding Apparatus
   2-3-2. Operations of Image Coding Apparatus
2-4. Fourth Embodiment
   2-4-1. Configuration of Image Coding Apparatus
   2-4-2. Operations of Image Coding Apparatus

3. Regarding Image Decoding Apparatus
3-1. First Embodiment
   3-1-1. Configuration of Image Decoding Apparatus
   3-1-2. Operations of Image Decoding Apparatus
3-2. Second Embodiment
   3-2-1. Configuration of Image Decoding Apparatus
   3-2-2. Operations of Image Decoding Apparatus

4. Exemplary Operations of Image Processing Apparatus

5. Regarding Syntaxes Relating to Transmission of Plurality of Types of Coefficients

6. Regarding Quantization Parameters in Case Where Plurality of Types of Coefficients Is Transmitted

7. Application Examples

### 1. Overview of Image Processing Apparatus

In an image processing apparatus of the present technique, a plurality of types of coefficients produced from image data in respective transform processing blocks is quantized for each of the types to produce a plurality of corresponding types of quantized data, the quantized data for each of the plurality of types is coded, and then, a coded stream (a bit stream) is produced. Moreover, the image processing apparatus executes decoding of the coded stream, acquires the quantized data corresponding to each of the plurality of types of coefficients, and executes an inverse quantization of the acquired quantized data to produce the coefficient for each of the types. The image processing apparatus produces image data for each of the types of the coefficients from the produced coefficients, and executes a computation process that uses the image data to produce decoded image data.

Next, for a case where transform coefficients acquired by executing the orthogonal transform and transform-skipping coefficients acquired by executing a transform-skipping process for the orthogonal transform are used as the plurality of types of coefficients, each of such apparatuses will be described as an image coding apparatus that executes coding of the image data to produce a coded stream and an image decoding apparatus that executes decoding of the coded stream to produce decoded image data.

### 2. Regarding Image Coding Apparatus

### 2-1. First Embodiment

In a first embodiment of the image coding apparatus, an orthogonal transform and a transform-skipping process are executed for each of transform processing blocks (for example, for each TU), for residual data that indicates the difference between image data to be coded and predicted image data. Moreover, the image coding apparatus codes the quantized data of the transform coefficient acquired by the orthogonal transform and the quantized data of the transform-skipping coefficient acquired by executing the transform-skipping process, to produce the coded stream.

### 2-1-1. Configuration of Image Coding Apparatus

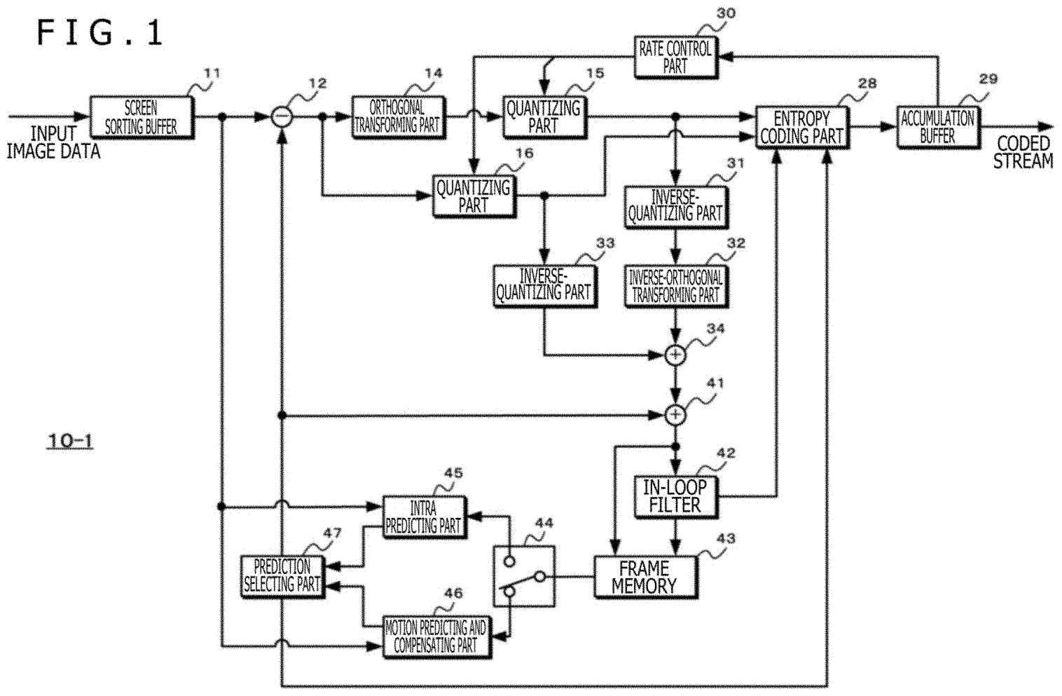

FIG. 1 exemplifies a configuration of the first embodiment of the image coding apparatus. An image coding apparatus 10-1 executes coding for input image data to produce a coded stream.

The image coding apparatus 10-1 includes a screen sorting buffer 11, a computing part 12, an orthogonal transforming part 14, quantizing parts 15 and 16, an entropy coding part 28, an accumulation buffer 29, and a rate control part 30. Moreover, the image coding apparatus 10-1 includes inverse-quantizing parts 31 and 33, an inverse-orthogonal transforming part 32, computing parts 34 and 41, an in-loop filter 42, a frame memory 43, and a selecting part 44. Furthermore, the image coding apparatus 10-1 includes an intra predicting part 45, a motion predicting and compensating part 46, and a prediction selecting part 47.

The screen sorting buffer 11 stores therein image data of an input image and sorts stored frame images in a display order into those in an order (coding order) for coding in accordance with a GOP (Group Of Picture) structure. The screen sorting buffer 11 outputs the image data to be coded (original image data) set in the coding order to the computing part 12. Moreover, the screen sorting buffer 11 outputs the image data to the intra predicting part 45 and the motion predicting and compensating part 46.

The computing part 12 subtracts, for each pixel position, predicted image data to be supplied from the intra predicting part 45 or the motion predicting and compensating part 46 through the prediction selecting part 47, from the original image data supplied from the screen sorting buffer 11 to produce residual data that indicates a prediction residue. The computing part 12 outputs the produced residual data to the orthogonal transforming part 14 and the quantizing part 16.

For example, in the case of images to be intra-coded, the computing part 12 subtracts the predicted image data produced by the intra predicting part 45 from the original image data. Moreover, for example, in the case of images to be inter-coded, the computing part 12 subtracts the predicted image data produced by the motion predicting and compensating part 46 from the original image data.

The orthogonal transforming part 14 applies an orthogonal transform such as a discrete cosine transform or a Karhunen-Loeve transform for the residual data to be supplied from the computing part 12, and outputs the transform coefficient thereof to the quantizing part 15.

The quantizing part 15 quantizes the transform coefficient to be supplied from the orthogonal transforming part 14 and outputs the quantization result to the entropy coding part 28 and the inverse-quantizing part 31. Note that the quantized data of the transform coefficient is referred to as “transform quantized data.”

The quantizing part 16 quantizes transform-skipping coefficient acquired by executing a transform-skipping process that skips the orthogonal transform for the residual data produced by the computing part 12, that is, transform-skipping coefficient indicating the residual data, and outputs the quantization result to the entropy coding part 28 and the inverse-quantizing part 33. Note that the quantized data of the transform-skipping coefficient is referred to as “transform-skipping quantized data.”

The entropy coding part 28 executes an entropy coding process, for example, an arithmetic coding process such as CABAC (Context-Adaptive Binary Arithmetic Coding) for the transform quantized data supplied from the quantizing part 15 and the transform-skipping quantized data supplied from the quantizing part 16. Moreover, the entropy coding part 28 acquires parameters of a prediction mode selected by the prediction selecting part 47, for example, parameters such as information indicating an intra prediction mode, or parameters such as information indicating an inter prediction mode and motion vector information. Furthermore, the entropy coding part 28 acquires parameters relating to a filtering process from the in-loop filter 42. The entropy coding part 28 entropy-codes the transform quantized data and the transform-skipping quantized data as well as the acquired parameters (syntax elements), and then causes the accumulation buffer 29 to accumulate therein the entropy-coded results (being multiplexed) as part of header information.

The accumulation buffer 29 temporarily retains therein the coded data supplied from the entropy coding part 28 and outputs at a predetermined timing the coded data as a coded stream to, for example, a recording apparatus, a transmission path, and the like in the subsequent stage which are not depicted.

The rate control part 30 controls the rate of the quantization operations of the quantizing parts 15 and 16 on the basis of compressed images accumulated in the accumulation buffer 29 so as to prevent generation of an overflow or an underflow.

The inverse-quantizing part 31 inverse-quantizes the transform quantized data supplied from the quantizing part 15 using a method corresponding to the quantization executed by the quantizing part 15. The inverse-quantizing part 31 outputs the acquired inverse-quantized data, that is, the transform coefficient to the inverse-orthogonal transforming part 32.

The inverse-orthogonal transforming part 32 inverse-orthogonal transforms the transform coefficient supplied from the inverse-quantizing part 31 using a method corresponding to the orthogonal transform process executed by the orthogonal transforming part 14. The inverse-orthogonal transforming part 32 outputs the inverse orthogonal transform result, that is, decoded residual data to the computing part 34.

The inverse-quantizing part 33 inverse-quantizes the transform-skipping quantized data supplied from the quantizing part 16 using a method corresponding to the quantization executed by the quantizing part 16. The inverse-quantizing part 33 outputs the acquired inverse-quantized data, that is, the residual data to the computing part 34.

The computing part 34 adds the residual data supplied from the inverse-orthogonal transforming part 32 and the residual data supplied from the inverse-quantizing part 33 to each other and outputs the addition result to the computing part 41 as decoded residual data.

The computing part 41 adds the predicted image data to be supplied from the intra predicting part 45 or the motion predicting and compensating part 46 through the prediction selecting part 47, to the decoded residual data supplied from the computing part 34 to acquire locally decoded image data (decoded image data). For example, in a case where the residual data corresponds to an image to be intra-coded, the computing part 41 adds the predicted image data to be supplied from the intra predicting part 45 to the residual data. Moreover, for example, in a case where the residual data corresponds to an image to be inter-coded, the computing part 34 adds the predicted image data to be supplied from the motion predicting and compensating part 46 to the residual data. The computing part 34 outputs the decoded image data that is the addition result to the in-loop filter 42. Moreover, the computing part 34 outputs the decoded image data to the frame memory 43 as reference image data.

The in-loop filter 42 includes at least any of, for example, a deblocking filter, an adaptive offset filter, or an adaptive loop filter. The deblocking filter removes block distortion of the decoded image data by executing a deblocking filtering process. The adaptive offset filter executes an adaptive offset filtering process (SAO (Sample Adaptive Offset) process) to suppress ringing and reduce an error of a pixel value in the decoded image generated in a gradation image or the like. The in-loop filter 42 includes, for example, a two-dimensional wiener filter or the like and executes an adaptive loop filtering (ALF) process to remove coding distortion. The in-loop filter 42 outputs the decoded image data after the filtering process to the frame memory 43 as reference image data. Moreover, the in-loop filter 42 outputs the parameters relating to the filtering process to the entropy coding part 28.

The reference image data accumulated in the frame memory 43 is output at a predetermined timing to the intra predicting part 45 or the motion predicting and compensating part 46 through the selecting part 44. For example, in the case of images to be intra-coded, the reference image data which is not filtered by the in-loop filter 42 is read from the frame memory 43, and is output to the intra predicting part 45 through the selecting part 44. Moreover, for example, in a case where the inter coding is executed, the reference image data which is filtered by the in-loop filter 42 is read from the frame memory 43 and is output to the motion predicting and compensating part 46 through the selecting part 44.

The intra predicting part 45 executes intra prediction (in-screen prediction) that produces predicted image data using the pixel value in the screen. The intra predicting part 45 produces the predicted image data for each of all the intra prediction modes, using the decoded image data produced by the computing part 41 and stored in the frame memory 43, as the reference image data.

Moreover, the intra predicting part 45 executes calculation and the like of the cost of each of the intra prediction modes (for example, a rate distortion cost), using the original image data and the predicted image data supplied from the screen sorting buffer 11, and selects the optimal mode in which the calculated cost becomes minimal. When the intra predicting part 45 selects the optimal intra prediction mode, the intra predicting part 45 outputs the predicted image data in the selected intra prediction mode, parameters such as intra prediction mode information indicating the selected intra prediction mode, the cost, and the like to the prediction selecting part 47.

For the image to be inter-coded, the motion predicting and compensating part 46 executes motion prediction using the original image data supplied from the screen sorting buffer 11 and the decoded image data which is filtered and then stored in the frame memory 43, as the reference image data. Moreover, the motion predicting and compensating part 46 executes a motion compensation process in accordance with the motion vector detected by the motion prediction to produce the predicted image data.

The motion predicting and compensating part 46 executes an inter prediction process for all the inter prediction modes as candidates, executes calculation and the like of the cost (for example, a rate distortion cost) by producing the predicted image data for each of all the intra prediction modes, and selects the optimal mode in which the calculated cost becomes minimal. When the motion predicting and compensating part 46 selects the optimal inter prediction mode, the motion predicting and compensating part 46 outputs the predicted image data of the selected inter prediction mode, the parameters such as the inter prediction mode information indicating the selected inter prediction mode, and motion vector information indicating the calculated motion vector, the cost, and the like to the prediction selecting part 47.

The prediction selecting part 47 selects the optimal prediction process on the basis of the cost for the intra prediction mode and the cost for the inter prediction mode. When the prediction selecting part 47 selects the intra prediction process, the prediction selecting part 47 outputs the predicted image data supplied from the intra predicting part 45 to the computing part 12 and the computing part 41, and outputs the parameters such as the intra prediction mode information to the entropy coding part 28. When the prediction selecting part 47 selects the inter prediction process, the prediction selecting part 47 outputs the predicted image data supplied from the motion predicting and compensating part 46 to the computing part 12 and the computing part 41, and outputs the parameters such as the inter prediction mode information and the motion vector information to the entropy coding part 28.

### 2-1-2. Operations of Image Coding Apparatus

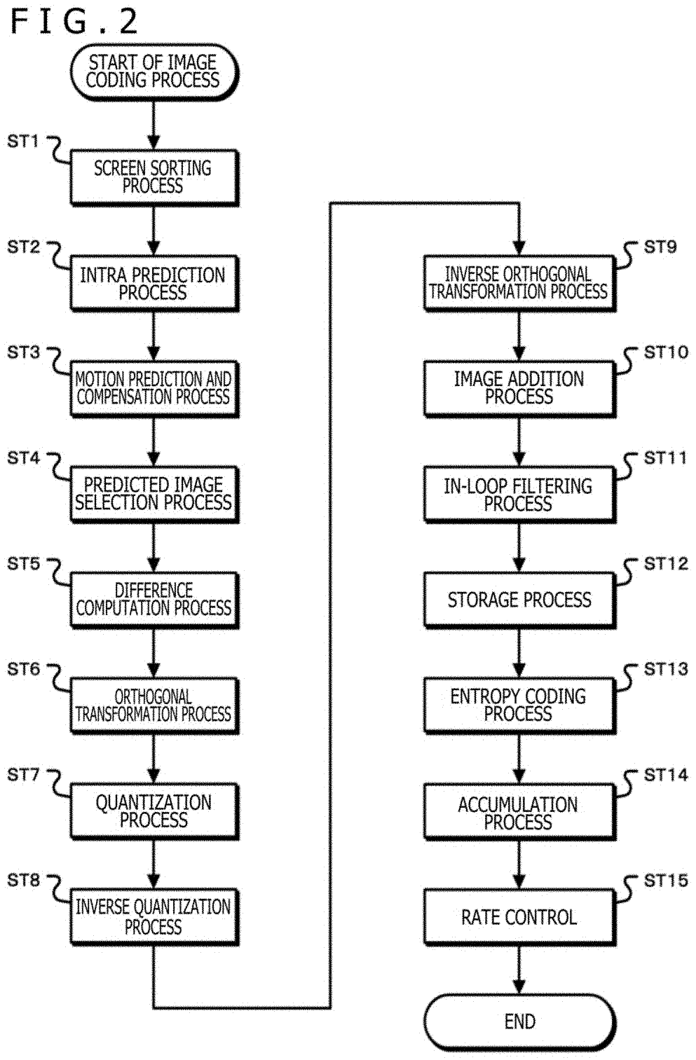

Operations of the first embodiment of the image coding apparatus will next be described. FIG. 2 is a flowchart exemplifying operations of the image coding apparatus.

At step ST1, the image coding apparatus executes the screen sorting process. The screen sorting buffer 11 of the image coding apparatus 10-1 sorts the frame images in the display order into those in coding order and outputs the sorted result to the intra predicting part 45 and the motion predicting and compensating part 46.

At step ST2, the image coding apparatus executes the intra prediction process. The intra predicting part 45 of the image coding apparatus 10-1 executes intra prediction for the pixel of the block to be processed in all the intra prediction modes as the candidates using the reference image data read from the frame memory 43 to produce the predicted image data. Moreover, the intra predicting part 45 calculates the cost using the produced predicted image data and the original image data. Note that the decoded image data which is not filtered by the in-loop filter 42 is used as the reference image data. The intra predicting part 45 selects the optimal intra prediction mode on the basis of the calculated cost and outputs the predicted image data produced by the intra prediction in the optimal intra prediction mode, the parameters, and the cost to the prediction selecting part 47.

At step ST3, the image coding apparatus executes a motion prediction and compensation process. The motion predicting and compensating part 46 of the image coding apparatus 10-1 executes inter prediction for the pixels of a block to be processed in all the inter prediction modes as the candidates to produce the predicted image data. Moreover, the motion predicting and compensating part 46 calculates the cost using the produced predicted image data and the original image data. Note that the decoded image data which is filtered by the in-loop filter 42 is used as the reference image data. The motion predicting and compensating part 46 determines the optimal inter prediction mode on the basis of the calculated cost, and outputs the predicted image data produced using the optimal inter prediction mode, the parameters, and the cost to the prediction selecting part 47.

At step ST4, the image coding apparatus executes a predicted image selection process. The prediction selecting part 47 of the image coding apparatus 10-1 determines one of the optimal intra prediction mode and the optimal inter prediction mode as the optimal prediction mode on the basis of the costs calculated at step ST2 and step ST3. The prediction selecting part 47 next selects the predicted image data of the determined optimal prediction mode and outputs the selected predicted image data to the computing parts 12 and 41. Note that the predicted image data is used in computation at each of steps ST5 and ST10 described later. Moreover, the prediction selecting part 47 outputs the parameter relating to the optimal prediction mode to the entropy coding part 28.

At step ST5, the image coding apparatus executes a difference computation process. The computing part 12 of the image coding apparatus 10-1 calculates the difference between the original image data sorted at step ST1 and the predicted image data selected at step ST4, and outputs the residual data to be the differential result to the orthogonal transforming part 14 and the quantizing part 16.

At step ST6, the image coding apparatus executes an orthogonal transform process. The orthogonal transforming part 14 of the image coding apparatus 10-1 orthogonal-transforms the residual data supplied from the computing part 12. More specifically, the orthogonal transforming part 14 executes an orthogonal transform such as a discrete cosine transform or a Karhunen-Loeve transform, and outputs the acquired transform coefficient to the quantizing part 15.

At step ST7, the image coding apparatus executes a quantization process. The quantizing part 15 of the image coding apparatus 10-1 quantizes the transform coefficient supplied from the orthogonal transforming part 14 to produce transform quantized data. The quantizing part 15 outputs the produced transform quantized data to the entropy coding part 28 and the inverse-quantizing part 31. Moreover, the quantizing part 16 quantizes the transform-skipping coefficient (the residual data) acquired by executing the transform-skipping process for the residual data produced by the computing part 12, to produce transform-skipping quantized data. The quantizing part 16 outputs the produced transform-skipping quantized data to the entropy coding part 28 and the inverse-quantizing part 33. In this quantization, rate control is executed as described in the process at step ST15 described later.

The quantized data produced as above is locally decoded as follows. In other words, at step ST8, the image coding apparatus executes an inverse quantization process. The inverse-quantizing part 31 of the image coding apparatus 10-1 inverse-quantizes the transform quantized data supplied from the quantizing part 15 using the property corresponding to the quantizing part 15, and outputs the acquired transform coefficient to the inverse-orthogonal transforming part 32. Moreover, the inverse-quantizing part 33 of the image coding apparatus 10-1 inverse-quantizes the transform-skipping quantized data supplied from the quantizing part 16 using the property corresponding to the quantizing part 16, and outputs the acquired residual data to the computing part 34.

At step ST9, the image coding apparatus executes an inverse orthogonal transform process. The inverse-orthogonal transforming part 32 of the image coding apparatus 10-1 inverse-orthogonal transforms the inverse-quantized data acquired by the inverse-quantizing part 31, that is, the transform coefficient using the property corresponding to the orthogonal transforming part 14, and outputs the acquired residual data to the computing part 34.

At step ST10, the image coding apparatus executes an image addition process. The computing part 34 of the image coding apparatus 10-1 adds the residual data acquired by executing the inverse quantization by the inverse-quantizing part 33 at step ST8 and the residual data acquired by executing the inverse orthogonal transform by the inverse-orthogonal transforming part 32 at step ST9 to each other to thereby produce the locally decoded residual data. Moreover, the computing part 41 adds the locally decoded residual data and the predicted image data selected at step ST4 to each other, to thereby produce decoded image data which is locally decoded (that is, local-decoded), and outputs the decoded image data to the in-loop filter 42 and the frame memory 43.

At step ST11, the image coding apparatus executes an in-loop filtering process. The in-loop filter 42 of the image coding apparatus 10-1 executes at least any filtering process of, for example, a deblocking filtering process, the SAO process, or the adaptive loop filtering process, for the decoded image data produced by the computing part 41. The in-loop filter 42 outputs the decoded image data after the filtering process to the frame memory 43.

At step ST12, the image coding apparatus executes a storage process. The frame memory 43 of the image coding apparatus 10-1 stores therein the decoded image data before the in-loop filtering process supplied from the computing part 41 and the decoded image data from the in-loop filter 42, the decoded image date on which the in-loop filtering process has been executed at step ST11, as the reference image data.

At step ST13, the image coding apparatus executes an entropy coding process. The entropy coding part 28 of the image coding apparatus 10-1 codes the pieces of transform quantized data supplied from the quantizing parts 15 and 16, the transform-skipping quantized data, the parameters supplied from the in-loop filter 42 and the prediction selecting part 47, and the like, and outputs the coding result to the accumulation buffer 29.

At step ST14, the image coding apparatus executes an accumulation process. The accumulation buffer 29 of the image coding apparatus 10-1 accumulates therein the coded data supplied from the entropy coding part 28. The coded data accumulated in the accumulation buffer 29 is appropriately read and is supplied to the decoding side through a transmission path or the like.

At step ST15, the image coding apparatus executes rate control. The rate control part 30 of the image coding apparatus 10-1 executes rate control for the quantization operation of each of the quantizing parts 15 and 16 so as to prevent generation of an overflow or an underflow of the coded data accumulated in the accumulation buffer 29.

In this manner, in the first embodiment, the transform coefficient after the orthogonal transform and the transform-skipping coefficient are included in the coded stream and are transmitted from the image coding apparatus to the image decoding apparatus. Degradation in image quality due to a mosquito noise and the like can therefore be suppressed compared to a decoded image decoded by executing quantization, inverse quantization, and the like for the transform coefficient after the orthogonal transform. Moreover, failure in gradation can be alleviated compared to a decoded image decoded by executing quantization, inverse quantization, and the like for the transform-skipping coefficient. Suppression of lowering in high image quality of the decoded image is therefore enabled compared to a case where any of the transform coefficient or the transform-skipping coefficient is included in the coded stream.

Moreover, in the first embodiment, because the transform coefficient and the transform-skipping coefficient are each independently and concurrently calculated and quantized, the coding process can be executed at a high speed even in a case where the transform coefficient and the transform-skipping coefficient are included in the coded stream.

### 2-2. Second Embodiment

A second embodiment of the image coding apparatus will next be described. The image coding apparatus executes an orthogonal transform for each transform process block for residual data that indicates the difference between the image to be coded and a predicted image. Moreover, the image coding apparatus calculates an error generated in the residual data decoded by executing the quantization, the inverse quantization, and the inverse orthogonal transform for a transform coefficient acquired by the orthogonal transform. Furthermore, acquiring a transform-skipping coefficient by skipping the orthogonal transform for the calculated error residual data, the image coding apparatus codes the transform coefficient and the transform-skipping coefficient to produce a coded stream.

### 2-2-1. Configuration of Image Coding Apparatus

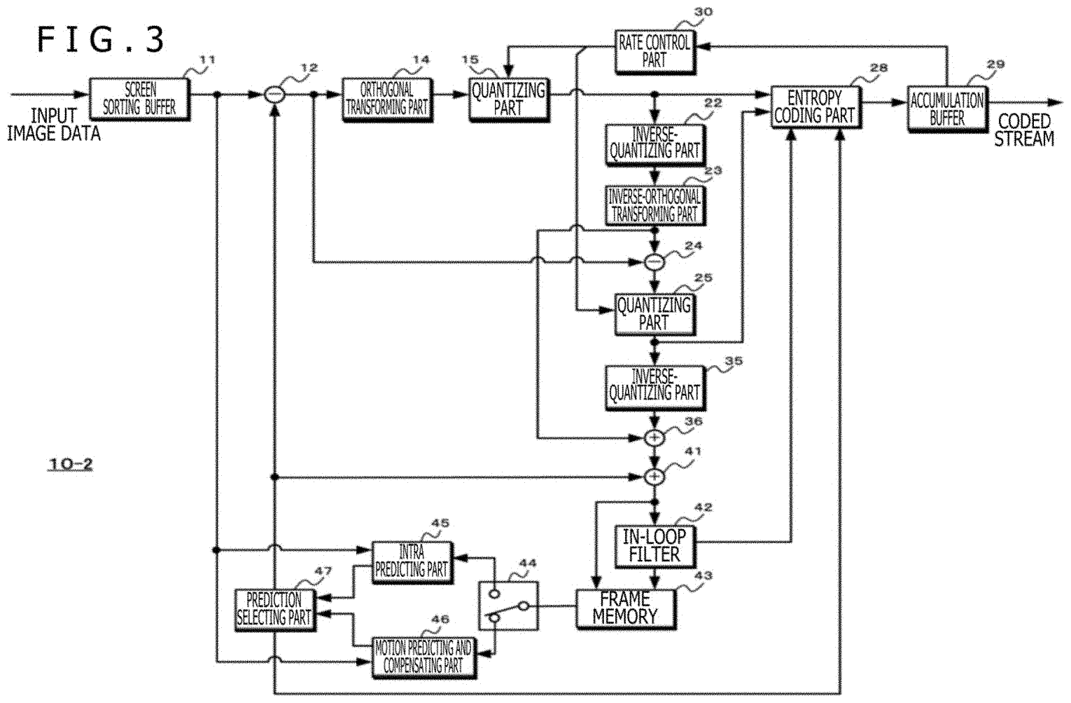

FIG. 3 exemplifies a configuration of the second embodiment of the image coding apparatus. The image coding apparatus 10-2 executes the coding for the original image data to produce the coded stream.

The image coding apparatus 10-2 includes the screen sorting buffer 11, computing parts 12 and 24, the orthogonal transforming part 14, the quantizing part 15, an inverse-quantizing part 22, an inverse-orthogonal transforming part 23, a quantizing part 25, the entropy coding part 28, the accumulation buffer 29, and the rate control part 30. Moreover, the image coding apparatus 10-2 includes an inverse-quantizing part 35, computing parts 36 and 41, the in-loop filter 42, the frame memory 43, and the selecting part 44. Furthermore, the image coding apparatus 10-2 includes the intra predicting part 45, the motion predicting and compensating part 46, and the prediction selecting part 47.

The screen sorting buffer 11 stores therein image data of an input image and sorts stored frame images in the display order into those in the order for coding in accordance with a GOP (Group of Picture) structure (coding order). The screen sorting buffer 11 outputs the image data to be coded (original image data) set in the coding order to the computing part 12. Moreover, the screen sorting buffer 11 outputs the image data to the intra predicting part 45 and the motion predicting and compensating part 46.

The computing part 12 subtracts, for each pixel position, predicted image data supplied from the intra predicting part 45 or the motion predicting and compensating part 46 through the prediction selecting part 47, from the original image data supplied from the screen sorting buffer 11 to produce residual data that indicates the prediction residue. The computing part 12 outputs the produced residual data to the orthogonal transforming part 14.

The orthogonal transforming part 14 applies an orthogonal transform such as a discrete cosine transform or a Karhunen-Loeve transform for the residual data supplied from the computing part 12, and outputs the transform coefficient thereof to the quantizing part 15.

The quantizing part 15 quantizes the transform coefficient supplied from the orthogonal transforming part 14 and outputs the quantization result to the inverse-quantizing part 22 and the entropy coding part 28.

The inverse-quantizing part 22 inverse-quantizes the transform quantized data supplied from the quantizing part 15 using a method corresponding to the quantization executed by the quantizing part 15. The inverse-quantizing part 22 outputs the acquired inverse-quantized data, that is, the transform coefficient to the inverse-orthogonal transforming part 23.

The inverse-orthogonal transforming part 23 inverse-orthogonal transforms the transform coefficient supplied from the inverse-quantizing part 22 using a method corresponding to the orthogonal transform process executed by the orthogonal transforming part 14. The inverse-orthogonal transforming part 23 outputs the inverse orthogonal transform result, that is, decoded residual data to each of the computing parts 24 and 36.

The computing part 24 subtracts the decoded residual data supplied from the inverse-orthogonal transforming part 23 from the differential data supplied from the computing part 12, calculates the data indicating an error generated by executing the orthogonal transform, the quantization, the inverse quantization, and the inverse orthogonal transform (hereinafter, referred to as “transform error data”), and outputs the calculated data to the quantizing part 25 as a transform-skipping coefficient with the orthogonal transform skipped.

The quantizing part 25 quantizes the transform-skipping coefficient supplied from the computing part 24 to produce transform error quantized data. The quantizing part 25 outputs the produced transform-skipping quantized data to the entropy coding part 28 and the inverse-quantizing part 35.

The entropy coding part 28 executes an entropy coding process, for example, an arithmetic coding process such as CABAC (Context-Adaptive Binary Arithmetic Coding) for the transform quantized data supplied from the quantizing part 15 and the transform-skipping quantized data supplied from the quantizing part 25. Moreover, the entropy coding part 28 acquires parameters in the prediction mode selected by the prediction selecting part 47, for example, parameters such as information indicating the intra prediction mode, or parameter such as information indicating the inter prediction mode or motion vector information. Furthermore, the entropy coding part 28 acquires a parameter relating to a filtering process from the in-loop filter 42. The entropy coding part 28 entropy-codes the transform quantized data and the transform-skipping quantized data as well as the acquired parameters (syntax elements), and causes the accumulation buffer 29 to accumulate therein the entropy-coded results (being multiplexed) as part of header information.

The accumulation buffer 29 temporarily retains therein the coded data supplied from the entropy coding part 28 and outputs the coded data as a coded stream, at a predetermined timing to, for example, a recording apparatus, a transmission path, and the like in the subsequent stage and which are not depicted.

The rate control part 30 controls the rate of the quantization operations of the quantizing parts 15 and 25 on the basis of compressed images accumulated in the accumulation buffer 29 so as to prevent any generation of an overflow or an underflow.

The inverse-quantizing part 35 inverse-quantizes the transform-skipping quantized data supplied from the quantizing part 25 using a method corresponding to the quantization executed by the quantizing part 25. The inverse-quantizing part 35 outputs the acquired decoded transform error data to the computing part 36.

The computing part 36 adds the residual data decoded by the inverse-orthogonal transforming part 23 and the transform error data decoded by the inverse-quantizing part 35 to each other and outputs the addition result to the computing part 41 as decoded residual data.

The computing part 41 adds the predicted image data supplied from the intra predicting part 45 or the motion predicting and compensating part 46 through the prediction selecting part 47 to the decoded residual data supplied from the computing part 36 to acquire locally decoded image data (decoded image data). The computing part 41 outputs the decoded image data that is the addition result to the in-loop filter 42. Moreover, the computing part 41 outputs the decoded image data to the frame memory 43 as reference image data.

The in-loop filter 42 includes at least any of, for example, a deblocking filter, an adaptive offset filter, or an adaptive loop filter. The in-loop filter 42 executes a filtering process for the decoded image data and outputs the decoded image data after the filtering process to the frame memory 43 as reference image data. Moreover, the in-loop filter 42 outputs the parameters relating to the filtering process to the entropy coding part 28.

The reference image data accumulated in the frame memory 43 is output at a predetermined timing to the intra predicting part 45 or the motion predicting and compensating part 46 through the selecting part 44.

The intra predicting part 45 executes intra prediction (in-screen prediction) that produces predicted image data using the pixel value in the screen. The intra predicting part 45 produces the predicted image data for each of all the intra prediction modes, using the decoded image data produced by the computing part 41 and stored in the frame memory 43, as the reference image data. Moreover, the intra predicting part 45 executes calculation and the like of the cost of each of the intra prediction modes using the original image data supplied from the screen sorting buffer 11 and the predicted image data, and selects the optimal mode in which the calculated cost becomes minimal. The intra predicting part 45 outputs the predicted image data in the selected intra prediction mode, parameters such as intra prediction mode information indicating the selected intra prediction mode, the cost, and the like to the prediction selecting part 47.

For the image to be inter-coded, the motion predicting and compensating part 46 executes motion prediction using the original image data supplied from the screen sorting buffer 11 and the decoded image data which is filtered and is then stored in the frame memory 43, as the reference image data. Moreover, the motion predicting and compensating part 46 executes a motion compensation process in accordance with the motion vector detected by the motion prediction to produce the predicted image data.

The motion predicting and compensating part 46 executes an inter prediction process in all the inter prediction modes as candidates, executes calculation and the like of the cost by producing the predicted image data for each of all the intra prediction modes, and selects the optimal mode in which the calculated cost becomes minimal. The motion predicting and compensating part 46 outputs the predicted image data of the selected inter prediction mode, the parameters such as the inter prediction mode information indicating the selected inter prediction mode and motion vector information indicating the calculated motion vector, the cost, and the like to the prediction selecting part 47.

The prediction selecting part 47 selects the optimal prediction process on the basis of the costs of the intra prediction mode and the inter prediction mode. In a case where the prediction selecting part 47 selects the intra prediction process, the prediction selecting part 47 outputs the predicted image data supplied from the intra predicting part 45 to the computing part 12 and the computing part 41, and outputs the parameters such as the intra prediction mode information to the entropy coding part 28. In a case where the prediction selecting part 47 selects the inter prediction process, the prediction selecting part 47 outputs the predicted image data supplied from the motion predicting and compensating part 46 to the computing part 12 and the computing part 41, and outputs the parameters such as the inter prediction mode information and the motion vector information to the entropy coding part 28.

### 2-2-2. Operations of Image Coding Apparatus

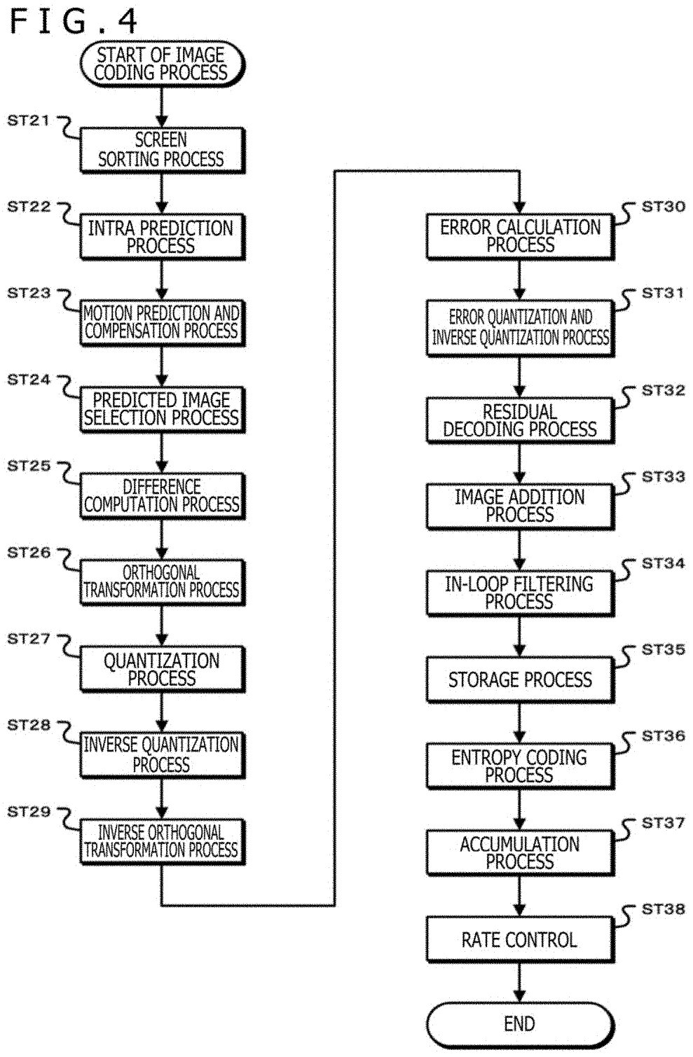

Operations of the second embodiment of the image coding apparatus will next be described. FIG. 4 is a flowchart exemplifying operations of the image coding apparatus. In addition, the same processes as those in the first embodiment will each simply be described.

At step ST21, the image coding apparatus executes the screen sorting process. The screen sorting buffer 11 of the image coding apparatus 10-2 sorts the frame images in the display order into those in coding order and outputs these to the intra predicting part 45 and the motion predicting and compensating part 46.

At step ST22, the image coding apparatus executes the intra prediction process. The intra predicting part 45 of the image coding apparatus 10-2 outputs the predicted image data produced in the optimal intra prediction mode, the parameters, and the cost to the prediction selecting part 47.

At step ST23, the image coding apparatus executes a motion prediction and compensation process. The motion predicting and compensating part 46 of the image coding apparatus 10-2 outputs the predicted image data produced using the optimal inter prediction mode, the parameters, and the cost to the prediction selecting part 47.

At step ST24, the image coding apparatus executes a predicted image selection process. The prediction selecting part 47 of the image coding apparatus 10-2 determines one of the optimal intra prediction mode and the optimal inter prediction mode as the optimal prediction mode on the basis of the costs calculated at step ST22 and step ST23. The prediction selecting part 47 next selects the predicted image data in the determined optimal prediction mode and outputs the predicted image data to the computing parts 12 and 41.

At step ST25, the image coding apparatus executes a difference computation process. The computing part 12 of the image coding apparatus 10-2 calculates the difference between the original image data sorted at step ST21 and the predicted image data selected at step ST24, and outputs the residual data as the differential result to the orthogonal transforming part 14 and the computing part 24.

At step ST26, the image coding apparatus executes an orthogonal transform process. The orthogonal transforming part 14 of the image coding apparatus 10-2 orthogonal-transforms the residual data supplied from the computing part 12 and outputs the acquired transform coefficient to the quantizing part 15.

At step ST27, the image coding apparatus executes a quantization process. The quantizing part 15 of the image coding apparatus 10-2 quantizes the transform coefficient supplied from the orthogonal transforming part 14 to produce transform quantized data. The quantizing part 15 outputs the produced transform quantized data to the inverse-quantizing part 22 and the entropy coding part 28.

At step ST28, the image coding apparatus executes an inverse quantization process. The inverse-quantizing part 22 of the image coding apparatus 10-2 inverse-quantizes the transform quantized data output from the quantizing part 15 using the property corresponding to the quantizing part 15, and outputs the acquired transform coefficient to the inverse-orthogonal transforming part 23.

At step ST29, the image coding apparatus executes an inverse orthogonal transform process. The inverse-orthogonal transforming part 23 of the image coding apparatus 10-2 inverse-orthogonal transforms the inverse-quantized data produced by the inverse-quantizing part 22, that is, the transform coefficient using the property corresponding to the orthogonal transforming part 14, and outputs the acquired residual data to the computing part 24 and the computing part 36.

At step ST30, the image coding apparatus executes an error calculation process. The computing part 24 of the image coding apparatus 10-2 subtracts the residual data acquired at step ST29 from the residual data calculated at step ST25 to produce transform error data, and outputs the transform error data to the quantizing part 25.

At step ST31, the image coding apparatus executes a quantization and inverse quantization process for an error. The quantizing part 25 of the image coding apparatus 10-2 quantizes the transform-skipping coefficient as the transform error data produced at step ST30 to produce the transform-skipping quantized data and outputs the transform-skipping quantized data to the entropy coding part 28 and the inverse-quantizing part 35. Moreover, the inverse-quantizing part 35 executes inverse quantization for the transform-skipping quantized data. The inverse-quantizing part 35 inverse-quantizes the transform-skipping quantized data supplied from the quantizing part 25 using the property corresponding to the quantizing part 25 and outputs the acquired transform error data to the computing part 36.

At step ST32, the image coding apparatus executes a residual decoding process. The computing part 36 of the image coding apparatus 10-2 adds the transform error data acquired by the inverse-quantizing part 35 and the residual data acquired by the inverse-orthogonal transforming part 23 at step ST29 to each other to produce decoded residual data and outputs the decoded residual data to the computing part 41.

At step ST33, the image coding apparatus executes an image addition process. The computing part 41 of the image coding apparatus 10-2 adds the decoded residual data locally decoded at step ST32 and the predicted image data selected at step ST24 to each other to thereby produce decoded image data that is locally decoded, and outputs the decoded image data to the in-loop filter 42 and the frame memory 43.

At step ST34, the image coding apparatus executes an in-loop filtering process. The in-loop filter 42 of the image coding apparatus 10-2 executes at least any filtering process of, for example, a deblocking filtering process, the SAO process, or the adaptive loop filtering process for the decoded image data produced by the computing part 41, and outputs the decoded image data after the filtering process to the frame memory 43.

At step ST35, the image coding apparatus executes a storage process. The frame memory 43 of the image coding apparatus 10-2 stores therein the decoded image data after the in-loop filtering process at step ST34 and the decoded image data before the in-loop filtering process, as the reference image data.

At step ST36, the image coding apparatus executes an entropy coding process. The entropy coding part 28 of the image coding apparatus 10-2 codes the pieces of transform quantized data supplied from the quantizing parts 15 and 25, the transform-skipping quantized data, the parameters supplied from the in-loop filter 42 and the prediction selecting part 47, and the like.

At step ST37, the image coding apparatus executes an accumulation process. The accumulation buffer 29 of the image coding apparatus 10-2 accumulates therein the coded data. The coded data accumulated in the accumulation buffer 29 is appropriately read and is transmitted to the decoding side through a transmission path or the like.

At step ST38, the image coding apparatus executes rate control. The rate control part 30 of the image coding apparatus 10-2 executes rate control for the quantization operation of each of the quantizing parts 15 and 25 so as to prevent generation of an overflow or an underflow of the coded data accumulated in the accumulation buffer 29.

According to the above second embodiment, even when the orthogonal transform of the residual data, the quantization and the inverse quantization of the transform coefficient acquired by the orthogonal transform, and the inverse orthogonal transform of the transform coefficient acquired by the inverse quantization are executed and an error is thereby generated in the decoded residual data, the transform error data indicating this error is quantized as the transform-skipping coefficient to be included in the coded stream. The decoded image data can therefore be produced without being influenced by the error by executing the decoding process using the transform coefficient and the transform-skipping coefficient as described later.

Moreover, according to the second embodiment, the intermediate and low regions such as gradation can be reproduced by the orthogonal transform coefficient and the high frequency portion such as an impulse unable to be reproduced by the orthogonal transform coefficient can be reproduced by the transform-skipping coefficient, that is, the transform error data. The reproducibility of the residual data is therefore excellent, and image quality degradation of the decoded image can be suppressed.

### 2-3. Third Embodiment

A third embodiment of the image coding apparatus will next be described. The image coding apparatus executes transform skipping for residual data that indicates the difference between the image to be coded and a predicted image for each of the transform processing blocks. Moreover, the image coding apparatus calculates an error generated in the residual data decoded by executing quantization and inverse quantization for transform-skipping coefficient after the transform skipping. Furthermore, the image coding apparatus executes an orthogonal transform for the calculated error residual data to produce a transform coefficient, and codes the transform-skipping coefficient and the transform coefficient to produce the coded stream.

### 2-3-1. Configuration of Image Coding Apparatus

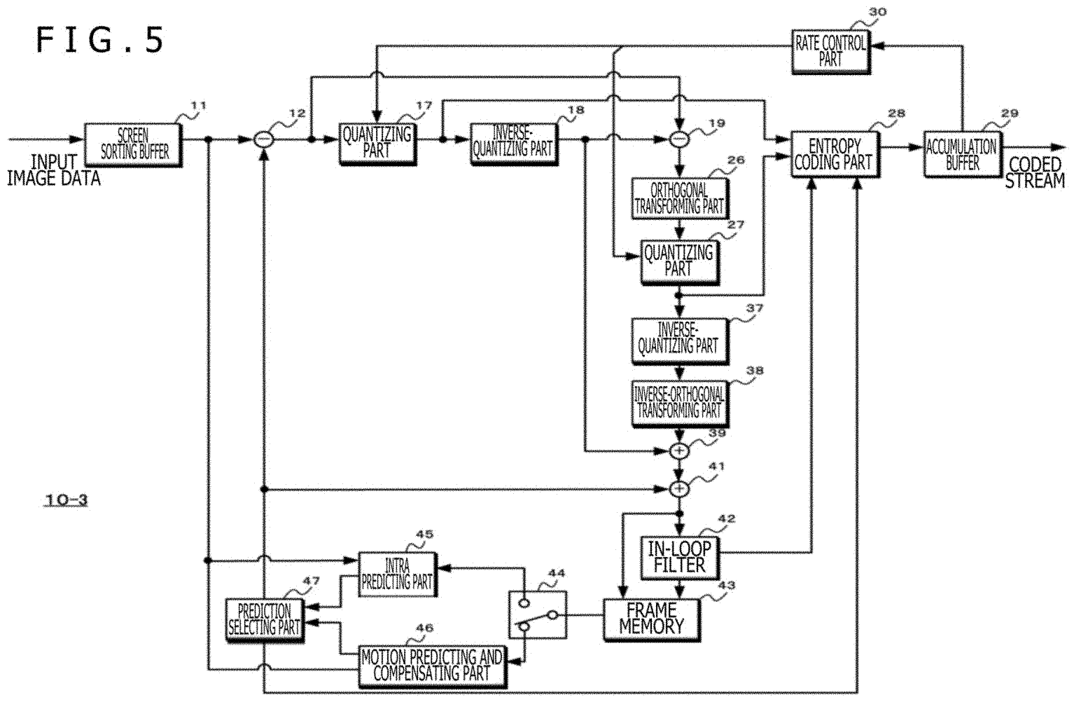

FIG. 5 exemplifies a configuration of the third embodiment of the image coding apparatus. The image coding apparatus 10-3 executes the coding for the original image data to produce the coded stream.

The image coding apparatus 10-3 includes the screen sorting buffer 11, the computing parts 12 and 19, quantizing parts 17 and 27, inverse-quantizing parts 18 and 37, the orthogonal transforming part 26, the entropy coding part 28, the accumulation buffer 29, and the rate control part 30. Moreover, the image coding apparatus 10-3 includes an inverse-quantizing part 37, an inverse-orthogonal transforming part 38, computing parts 39 and 41, the in-loop filter 42, the frame memory 43, and the selecting part 44. Furthermore, the image coding apparatus 10-3 includes the intra predicting part 45, the motion predicting and compensating part 46, and the prediction selecting part 47.

The screen sorting buffer 11 stores therein image data of an input image and sorts the stored frame images in the display order into those in the order for coding in accordance with a GOP (Group Of Picture) structure (coding order). The screen sorting buffer 11 outputs the image data to be coded (original image data) set in the coding order to the computing part 12. Moreover, the screen sorting buffer 11 outputs the image data to the intra predicting part 45 and the motion predicting and compensating part 46.

The computing part 12 subtracts, for each pixel position, the predicted image data supplied from the intra predicting part 45 or the motion predicting and compensating part 46 through the prediction selecting part 47, from the original image data supplied from the screen sorting buffer 11 to produce residual data that indicates a prediction residue. The computing part 12 outputs the produced residual data to the quantizing part 17 and the computing part 19.

The quantizing part 17 quantizes the transform-skipping coefficient acquired by executing a transform-skipping process that skips orthogonal transform of the residual data supplied from the computing part 12, that is, the transform-skipping coefficient indicating the residual data, and outputs the quantization result to the inverse-quantizing part 18 and the entropy coding part 28.

The inverse-quantizing part 18 inverse-quantizes the transform-skipping quantized data supplied from the quantizing part 17 using a method corresponding to the quantization executed by the quantizing part 17. The inverse-quantizing part 18 outputs the acquired inverse-quantized data to the computing parts 19 and 39.

The computing part 19 subtracts the decoded residual data supplied from the inverse-quantizing part 18 from the differential data supplied from the computing part 12 to calculate the data indicating an error generated by executing the quantization and the inverse quantization for the transform-skipping coefficient (hereinafter, referred to as “transform-skipping error data”), and then outputs the transform-skipping error data to the orthogonal transforming part 26.

The orthogonal transforming part 26 applies an orthogonal transform such as a discrete cosine transform or a Karhunen-Loeve transform for the transform-skipping residual data supplied from the computing part 19, and outputs the transform coefficient thereof to the quantizing part 27.

The quantizing part 27 quantizes the transform coefficient supplied from the orthogonal transforming part 26 and outputs transform quantized data to the entropy coding part 28 and the inverse-quantizing part 37.

The entropy coding part 28 executes an entropy coding process, for example, an arithmetic coding process such as, for example, CABAC (Context-Adaptive Binary Arithmetic Coding) for the transform-skipping quantized data supplied from the quantizing part 17 and the transform quantized data supplied from the quantizing part 27. Moreover, the entropy coding part 28 acquires parameters of the prediction mode selected by the prediction selecting part 47, for example, parameters such as information indicating the intra prediction mode, or parameters such as information indicating the inter prediction mode and motion vector information.

Furthermore, the entropy coding part 28 acquires a parameter relating to a filtering process from the in-loop filter 42. The entropy coding part 28 entropy-codes the transform quantized data and the transform-skipping quantized data as well as the acquired parameters (syntax elements), and causes the accumulation buffer 29 to accumulate therein the entropy-coded results (being multiplexed) as part of header information.

The accumulation buffer 29 temporarily retains therein the coded data supplied from the entropy coding part 28 and outputs at a predetermined timing the coded data as a coded stream to, for example, a recording apparatus, a transmission path, and the like in the subsequent stage which are not depicted.

The rate control part 30 controls the rate of the quantization operations of the quantizing parts 17 and 27 on the basis of compressed images accumulated in the accumulation buffer 29 so as to prevent generation of an overflow or an underflow.

The inverse-quantizing part 37 inverse-quantizes the transform quantized data supplied from the quantizing part 27 using a method corresponding to the quantization executed by the quantizing part 27. The inverse-quantizing part 37 outputs the acquired inverse-quantized data, that is, transform coefficient to the inverse-orthogonal transforming part 38.

The inverse-orthogonal transforming part 38 inverse-orthogonal transforms the transform coefficient supplied from the inverse-quantizing part 37 using a method corresponding to the orthogonal transform process executed by the orthogonal transforming part 26. The inverse-orthogonal transforming part 38 outputs the inverse orthogonal transform result, that is, decoded transform-skipping error data to the computing part 39.

The computing part 39 adds the residual data supplied from the inverse-quantizing part 18 and the transform-skipping error data supplied from the inverse-orthogonal transforming part 38 to each other and outputs the addition result to the computing part 41 as decoded residual data.

The computing part 41 adds the predicted image data supplied from the intra predicting part 45 or the motion predicting and compensating part 46 through the prediction selecting part 47 to the decoded residual data supplied from the computing part 39 to acquire locally decoded image data (decoded image data). The computing part 41 outputs the decoded image data that is the addition result to the in-loop filter 42. Moreover, the decoded image data is output to the frame memory 43 as reference image data.

The in-loop filter 42 includes at least any of, for example, a deblocking filter, an adaptive offset filter, or an adaptive loop filter. The in-loop filter 42 executes a filtering process for the decoded image data, and outputs the decoded image data after the filtering process to the frame memory 43 as reference image data. Moreover, the in-loop filter 42 outputs the parameters relating to the filtering process to the entropy coding part 28.

The reference image data accumulated in the frame memory 43 is output at a predetermined timing to the intra predicting part 45 or the motion predicting and compensating part 46 through the selecting part 44.

The intra predicting part 45 executes intra prediction (in-screen prediction) that produces predicted image data using the pixel value in the screen. The intra predicting part 45 produces the predicted image data for each of all the intra prediction modes, using the decoded image data produced by the computing part 41 and stored in the frame memory 43, as the reference image data. Moreover, the intra predicting part 45 executes calculation and the like of the cost of each of the intra prediction modes using the original image data supplied from the screen sorting buffer 11 and the predicted image data, and selects the optimal mode in which the calculated cost becomes minimal. The intra predicting part 45 outputs the predicted image data in the selected intra prediction mode, parameters such as intra prediction mode information indicating the selected intra prediction mode, the cost, and the like to the prediction selecting part 47.

For the image to be inter-coded, the motion predicting and compensating part 46 executes motion prediction using the original image data supplied from the screen sorting buffer 11 and the decoded image data which is filtered and is then stored in the frame memory 43, as the reference image data. Moreover, the motion predicting and compensating part 46 executes a motion compensation process in accordance with the motion vector detected by the motion prediction to produce the predicted image data.

The motion predicting and compensating part 46 executes an inter prediction process in all the inter prediction modes as candidates, executes calculation and the like of the cost by producing the predicted image data for each of all the intra prediction modes, and selects the optimal mode in which the calculated cost becomes optimal. The motion predicting and compensating part 46 outputs the predicted image data in the selected inter prediction mode, the parameters such as the inter prediction mode information indicating the selected inter prediction mode and motion vector information indicating the calculated motion vector, the cost, and the like to the prediction selecting part 47.

The prediction selecting part 47 selects the optimal prediction process on the basis of the costs of the intra prediction mode and the inter prediction mode. In a case where the prediction selecting part 47 selects the intra prediction process, the prediction selecting part 47 outputs the predicted image data supplied from the intra predicting part 45 to the computing part 12 and the computing part 41, and outputs the parameters such as the intra prediction mode information to the entropy coding part 28. In a case where the prediction selecting part 47 selects the inter prediction process, the prediction selecting part 47 outputs the predicted image data supplied from the motion predicting and compensating part 46 to the computing part 12 and the computing part 41, and outputs the parameters such as the inter prediction mode information and the motion vector information to the entropy coding part 28.

### 2-3-2. Operations of Image Coding Apparatus

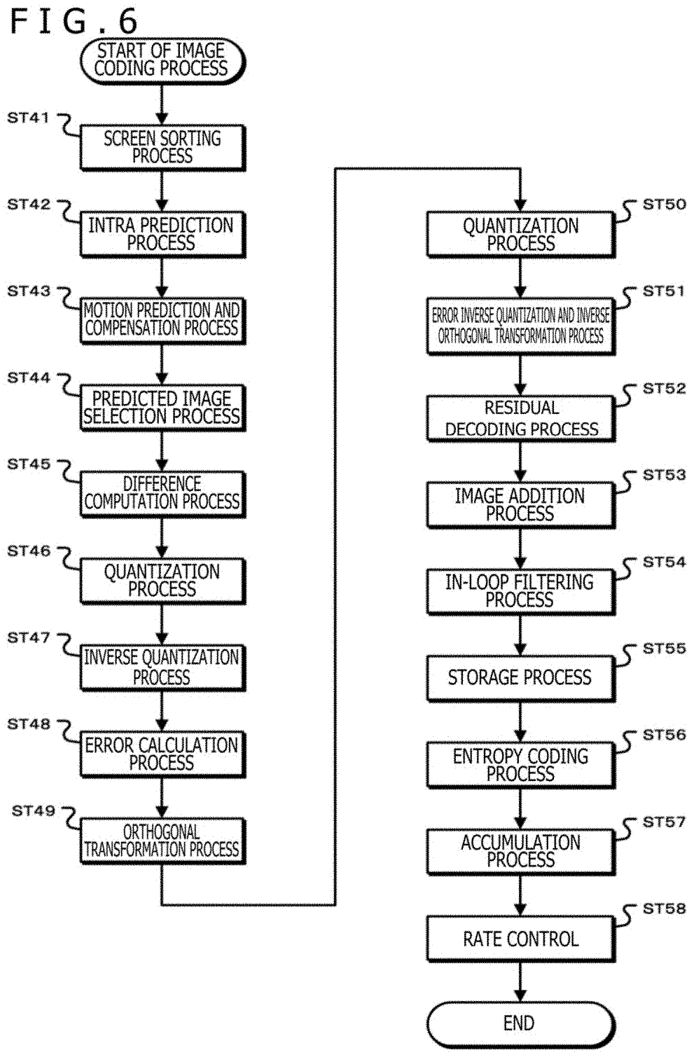

Operations of the third embodiment of the image coding apparatus will next be described. FIG. 6 is a flowchart exemplifying operations of the image coding apparatus.

At step ST41, the image coding apparatus executes the screen sorting process. The screen sorting buffer 11 of the image coding apparatus 10-3 sorts the frame images in the display order into those in coding order and outputs these to the intra predicting part 45 and the motion predicting and compensating part 46.

At step ST42, the image coding apparatus executes the intra prediction process. The intra predicting part 45 of the image coding apparatus 10-3 outputs the predicted image data produced in the optimal intra prediction mode, the parameters, and the costs to the prediction selecting part 47.

At step ST43, the image coding apparatus executes a motion predicting and compensating process. The motion predicting and compensating part 46 of the image coding apparatus 10-3 outputs the predicted image data produced using the optimal inter prediction mode, the parameters, and the cost to the prediction selecting part 47.

At step ST44, the image coding apparatus executes a predicted image selection process. The prediction selecting part 47 of the image coding apparatus 10-3 determines one of the optimal intra prediction mode or the optimal inter prediction mode as the optimal prediction mode on the basis of the costs calculated at step ST42 and step ST43. The prediction selecting part 47 next selects the predicted image data in the determined optimal prediction mode and outputs the selected predicted image data to the computing parts 12 and 41.

At step ST45, the image coding apparatus executes a difference computation process. The computing part 12 of the image coding apparatus 10-3 calculates the difference between the original image data sorted at step ST41 and the predicted image data selected at step ST44, and outputs the residual data that is the differential result to the quantizing part 17 and the computing part 19.

At step ST46, the image coding apparatus executes a quantization process. The quantizing part 17 of the image coding apparatus 10-3 quantizes transform-skipping coefficient acquired by executing the transform-skipping process for the residual data produced by the computing part 12 and outputs the transform-skipping quantized data to the inverse-quantizing part 18 and the entropy coding part 28. In this quantization, rate control is executed as described in the process at step ST58 described later.

At step ST47, the image coding apparatus executes an inverse quantization process. The inverse-quantizing part 18 of the image coding apparatus 10-3 outputs residual data acquired by inverse-quantizing the transform-skipping quantized data output from the quantizing part 17 using a property corresponding to the quantizing part 17, to the computing part 19 and the computing part 39.

At step ST48, the image coding apparatus executes an error calculation process. The computing part 19 of the image coding apparatus 10-3 subtracts the residual data acquired at step ST47 from the residual data calculated at step ST45 to produce transform-skipping error data indicating an error generated by executing the quantization and the inverse quantization for the transform-skipping coefficient, and outputs the transform-skipping error data to the orthogonal transforming part 26.

At step ST49, the image coding apparatus executes an orthogonal transform process. The orthogonal transforming part 14 of the image coding apparatus 10-3 orthogonal-transforms the transform-skipping error data supplied from the computing part 12 and outputs the acquired transform coefficient to the quantizing part 27.

At step ST50, the image coding apparatus executes a quantization process. The quantizing part 27 of the image coding apparatus 10-3 quantizes the transform coefficient supplied from the orthogonal transforming part 26 and outputs the acquired transform quantized data to the entropy coding part 28 and the inverse-quantizing part 37.

In this quantization, rate control is executed as described in the process at step ST58 described later.

At step ST51, the image coding apparatus executes an inverse quantization and inverse orthogonal transformation process for an error. The inverse-quantizing part 37 of the image coding apparatus 10-3 inverse-quantizes the transform quantized data supplied at step ST50 using the property corresponding to the quantizing part 27, and outputs the inverse quantization result to the inverse-orthogonal transforming part 38. Moreover, the inverse-orthogonal transforming part 38 of the image coding apparatus 10-3 inverse-orthogonal transforms the transform coefficient acquired by the inverse-quantizing part 37 using the property corresponding to the orthogonal transforming part 26 and outputs the acquired transform-skipping error data to the computing part 39.

At step ST52, the image coding apparatus executes a residual decoding process. The computing part 39 of the image coding apparatus 10-3 adds the transform-skipping error data acquired by the inverse-quantizing part 18 and the decoded residual data acquired by the inverse-orthogonal transforming part 38 at step ST51 to each other to produce decoded residual data, and outputs the decoded residual data to the computing part 41.

At step ST53, the image coding apparatus executes an image addition process. The computing part 41 of the image coding apparatus 10-3 adds the decoded residual data locally decoded at step ST52 and the predicted image data selected at step ST44 to each other to thereby produce decoded image data that is locally decoded, and outputs this decoded image data to the in-loop filter 42.

At step ST54, the image coding apparatus executes an in-loop filtering process. The in-loop filter 42 of the image coding apparatus 10-3 executes at least any filtering process of, for example, a deblocking filtering process, an SAO process, or an adaptive loop filtering process, for the decoded image data produced by the computing part 41, and outputs the decoded image data after the filtering process to the frame memory 43.

At step ST55, the image coding apparatus executes a storage process. The frame memory 43 of the image coding apparatus 10-3 stores therein the decoded image data after the in-loop filtering process at step ST54 and the decoded image data before the in-loop filtering process, as the reference image data.

At step ST56, the image coding apparatus executes an entropy coding process. The entropy coding part 28 of the image coding apparatus 10-3 codes the transform-skipping quantized data supplied from the quantizing part 17, the transform quantized data supplied from the quantizing parts 27, and the parameters supplied from the prediction selecting part 47 and the like, and outputs the coding results to the accumulation buffer 29.

At step ST57, the image coding apparatus executes an accumulation process. The accumulation buffer 29 of the image coding apparatus 10-3 accumulates therein the coded data supplied from the entropy coding part 28. The coded data accumulated in the accumulation buffer 29 is appropriately read and is transmitted to the decoding side through a transmission path or the like.

At step ST58, the image coding apparatus executes rate control. The rate control part 30 of the image coding apparatus 10-3 executes rate control for the quantization operation of each of the quantizing parts 17 and 27 so as to prevent generation of an overflow or an underflow of the coded data accumulated in the accumulation buffer 29.

According to the above third embodiment, even when the transform-skipping process, the quantization, and the inverse quantization are executed for the residual data and an error is thereby generated in the decoded residual data, the transform coefficient acquired by orthogonal-transforming the transform-skipping error data indicating this error is quantized and is included in the coded stream. The decoded image data can therefore be produced without being influenced by the error, by executing the decoding process using the transform coefficient and the transform-skipping coefficient as described later.

Moreover, according to the third embodiment, the high frequency portion such as an impulse can be reproduced by the transform-skipping coefficient and the intermediate and low region such as gradation unable to be reproduced by the transform-skipping coefficient can be reproduced by the orthogonal transform coefficient, and the reproducibility of the residual data is therefore excellent, and image quality degradation of the decoded image can be suppressed.

### 2-4. Fourth Embodiment

As to a fourth embodiment of the image coding apparatus, the image coding apparatus next executes the similar processes as those in the first embodiment using region separation data. The image coding apparatus executes separation of the frequency region or the spatial region, executes a coding process for one of the pieces of separation data using orthogonal transform, and executes a coding process for the other of the pieces of separation data using transform skipping. Note that, in the fourth embodiment, the configurations corresponding to those in the first embodiment will be given the same reference signs.

### 2-4-1. Configuration of Image Coding Apparatus

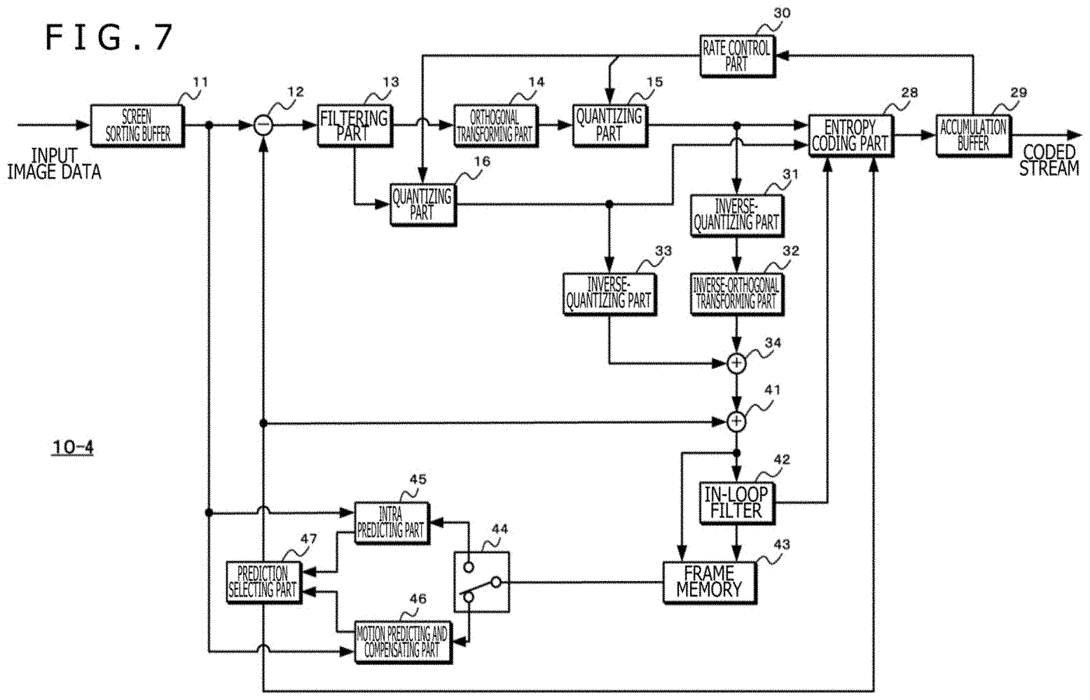

FIG. 7 exemplifies a configuration of the fourth embodiment of the image coding apparatus. The image coding apparatus 10-4 executes coding of original image data to produce a coded stream.

The image coding apparatus 10-4 includes the screen sorting buffer 11, the computing part 12, a filtering part 13, the orthogonal transforming part 14, the quantizing parts 15 and 16, the entropy coding part 28, the accumulation buffer 29, and the rate control part 30. Moreover, the image coding apparatus 10-4 includes the inverse-quantizing parts 31 and 33, the inverse-orthogonal transforming part 32, the computing parts 34 and 41, the in-loop filter 42, the frame memory 43, and the selecting part 44. Furthermore, the image coding apparatus 10-4 includes the intra predicting part 45, the motion predicting and compensating part 46, and the prediction selecting part 47.

The screen sorting buffer 11 stores therein image data of an input image and sorts stored frame images in the display order into those in the order for coding in accordance with a GOP (Group Of Picture) structure (coding order). The screen sorting buffer 11 outputs the image data to be coded (original image data) set in the coding order to the computing part 12. Moreover, the screen sorting buffer 11 outputs the image data to the intra predicting part 45 and the motion predicting and compensating part 46.

The computing part 12 subtracts, for each pixel position, predicted image data to be supplied from the intra predicting part 45 or the motion predicting and compensating part 46 through the prediction selecting part 47, from the original image data supplied from the screen sorting buffer 11 to produce residual data that indicates the prediction residue. The computing part 12 outputs the produced residual data to the filtering part 13.

The filtering part 13 executes a component separation process for the residual data to produce separation data. The filtering part 13 executes the separation in the frequency region or the spatial region using, for example, the residual data to produce the separation data.

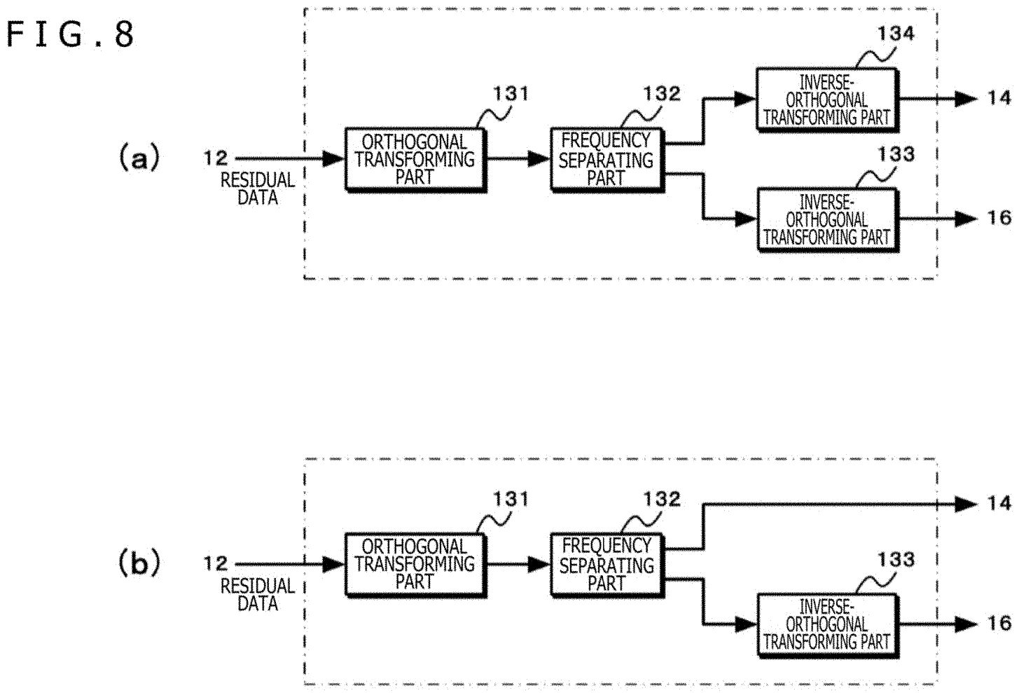

FIG. 8 depicts examples each illustrating a configuration of the filtering part in ae case where the component separation process is executed in the frequency region. As depicted in (a) of FIG. 8, the filtering part 13 includes an orthogonal transforming part 131, a frequency separating part 132, and inverse-orthogonal transforming parts 133 and 134.

The orthogonal transforming part 131 applies an orthogonal transform such as a discrete cosine transform or a Karhunen-Loeve transform for the residual data to transform the residual data from that in the spatial region to that in the frequency region. The orthogonal transforming part 131 outputs the transform coefficient acquired by the orthogonal transform to the frequency separating part 132.

The frequency separating part 132 separates the transform coefficient supplied from the orthogonal transforming part 131 into those in a first band including low frequencies and those in a second band including frequencies higher than those in the first band. The frequency separating part 132 outputs the transform coefficient in the first band to the inverse-orthogonal transforming part 133 and outputs the transform coefficient in the second band to the inverse-orthogonal transforming part 134.

The inverse-orthogonal transforming part 133 executes inverse orthogonal transform for the transform coefficient in the first band supplied from the frequency separating part 132 to transform the transform coefficient from those in the frequency region into those in the spatial region. The inverse-orthogonal transforming part 133 outputs the image data acquired by the inverse orthogonal transform to the orthogonal transforming part 14 as separation data.

The inverse-orthogonal transforming part 134 executes inverse orthogonal transform for the transform coefficient in the second band supplied from the frequency separating part 132 to transform the transform coefficient from those in the frequency region to those in the spatial region. The inverse-orthogonal transforming part 134 outputs the image data acquired by the inverse orthogonal transform to the quantizing part 16 as the separation data.

As above, the filtering part 13 executes the region separation for the residual data and, for example, outputs the image data of the frequency component in the first band that includes the low frequencies to the orthogonal transforming part 14 as the separation data and outputs the image data of the frequency component in the second band that includes frequencies higher than those in the first band to the quantizing part 16 as the separation data.

Concerning the above, in a case where the orthogonal transform executed by the orthogonal transforming part 131 is equivalent to the orthogonal transform executed by the orthogonal transforming part 14, the orthogonal transforming part 131 may also be used as the orthogonal transforming part 14. (b) of FIG. 8 exemplifies the configuration in a case where the orthogonal transforming part 131 is used as the orthogonal transforming part 14.

The filtering part 13 includes the orthogonal transforming part 131, the frequency separating part 132, and the inverse-orthogonal transforming part 134.

The orthogonal transforming part 131 applies an orthogonal transform such as a discrete cosine transform or a Karhunen-Loeve transform for the residual data to transform the residual data from that in the spatial region to that in the frequency region. The orthogonal transforming part 131 outputs the transform coefficient acquired by the orthogonal transform to the frequency separating part 132.

The frequency separating part 132 separates the transform coefficient supplied from the orthogonal transforming part 131 into those in the first band including low frequencies and those in the second band including frequencies higher than those in the first band. The frequency separating part 132 outputs the transform coefficient in the first band to the quantizing part 15 and outputs the transform coefficient in the second band to the inverse-orthogonal transforming part 134.

The inverse-orthogonal transforming part 134 executes inverse orthogonal transform for the transform coefficient in the second band supplied from the frequency separating part 132 to transform the transform coefficient from those in the frequency region into those in the spatial region. The inverse-orthogonal transforming part 134 outputs the image data acquired by the inverse orthogonal transform to the quantizing part 16 as separation data.

In this manner, the filtering part 13 executes the region separation for the residual data, outputs the transform coefficient that indicate the frequency component in the first band including the low frequencies to the quantizing part 15, and outputs the image data of the frequency component in the second band including frequencies higher than those in the first band to the quantizing part 16 as the separation data.

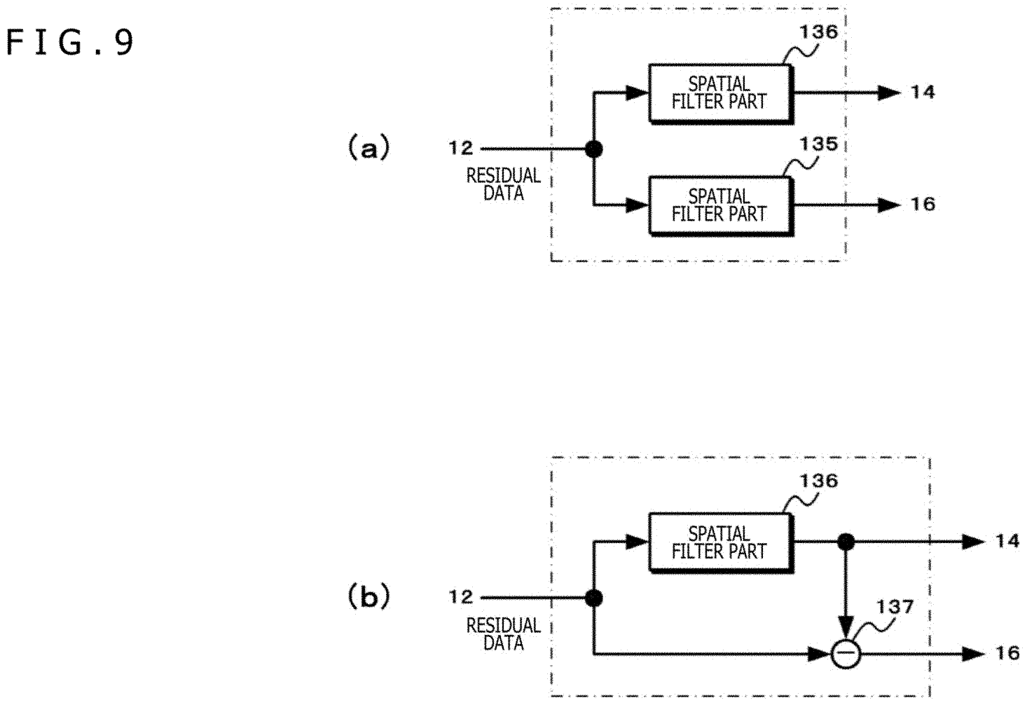

A case where a component separation process is executed in the spatial region using the residual data to produce the separation data will next be described. Using a space filter, the filtering part 13 separates, for example, an image indicated by the residual data into a smoothed image and a texture component image. FIG. 9 depicts examples each illustrating the configuration of the filtering part in a case where the component separation process is executed in the spatial region. As depicted in (a) of FIG. 9, the filtering part 13 includes space filters 135 and 136.

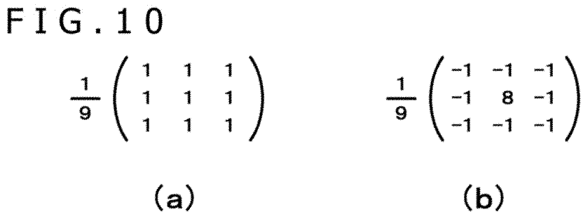

The space filter 135 executes a smoothing process using the residual data to produce a smoothed image. The space filter 135 executes a filtering process for the residual data using, for example, a moving-average filter or the like to produce image data of the smoothed image, and outputs the image data to the orthogonal transforming part 14. Incidentally, FIG. 10 depicts examples each illustrating a space filter, and (a) of FIG. 10 exemplifies a 3×3 moving-average filter.

The space filter 136 executes a texture component extraction process using the residual data to produce a texture component image. The space filter 136 executes a filtering process for the residual data using, for example, a Laplacian filter, a differential filter, or the like and outputs image data of a texture component image representing edges and the like to the quantizing part 16. Incidentally, (b) of FIG. 10 exemplifies a 3×3 Laplacian filter.

Moreover, the filtering part 13 may produce image data of a texture component image using the image data of the smoothed image. (b) of FIG. 9 exemplifies the configuration of the filtering part in a case where the image data of the texture component image is produced using the image data of the smoothed image. The filtering part 13 includes the space filter 135 and a subtracting part 137.

The space filter 135 executes the smoothing process using the residual data to produce the smoothed image. The space filter 135 executes a filtering process for the residual data using, for example, a moving-average filter or the like to produce the image data of the smoothed image, and outputs the image data to a subtracting part 137 and the orthogonal transforming part 14.

The subtracting part 137 subtracts the image data of the smoothed image produced by the space filter 135 from the residual data and outputs the subtraction result to the quantizing part 16 as the image data of the texture component image.

Moreover, a case where a linear filter such as the moving-average filter or the Laplacian filter is used has been described for the space filter depicted in FIG. 9, while a non-linear filter may be used as the filtering part 13. For example, because an expression by orthogonal transform is difficult for, for example, an impulse-like image and the like, a median filter having a high ability to remove any impulse-like image data is used as the space filter 135. The image having an impulse-like image removed therefrom can therefore be output to the orthogonal transforming part 14. Moreover, the image data after the filtering process produced by the space filter 135 is subtracted from the residual data, and the image data indicating the impulse-like image is output to the quantizing part 16.

Moreover, the configuration of the filtering part in a case where separation of the spatial region is executed is not limited to the cases depicted in FIG. 9. For example, the image data of the texture component image produced using a Laplacian filter, a differential filter, or the like is output to the quantizing part 16. Moreover, the image data acquired by subtracting the image data of the texture component image from the residual data may be output to the orthogonal transforming part 14 as the image data of the smoothed image.

In this manner, the filtering part 13 separates the image indicated by the residual data into two images whose properties differ from each other, and outputs the image data of one of the images to the orthogonal transforming part 14 as the separation data, and outputs the image data of the other of the images to the quantizing part 16 as the separation data.

The orthogonal transforming part 14 applies an orthogonal transform such as a discrete cosine transform or a Karhunen-Loeve transform for the separation data to be supplied from the filtering part 13, and outputs the transform coefficient thereof to the quantizing part 15.

The quantizing part 15 quantizes the transform coefficient to be supplied from the orthogonal transforming part 14 (or the filtering part 13) and outputs the quantization result to the entropy coding part 28 and the inverse-quantizing part 31. Note that the quantized data of the transform coefficient is referred to as “transform quantized data.”

The quantizing part 16 executes quantization for the separation data to be supplied from the filtering part 13 as transform-skipping coefficient, and outputs the acquired transform-skipping quantized data to the entropy coding part 28 and the inverse-quantizing part 33.

The entropy coding part 28 executes an entropy coding process such as arithmetic coding or the like for the transform quantized data supplied from the quantizing part 15 and the transform-skipping quantized data supplied from the quantizing part 16. Moreover, the entropy coding part 28 acquires a parameter for a prediction mode selected by the prediction selecting part 47 such as, for example, a parameter such as information indicating an intra prediction mode, or parameters such as information indicating an inter prediction mode and motion vector information. Furthermore, the entropy coding part 28 acquires a parameter relating to a filtering process from the in-loop filter 42. The entropy coding part 28 codes the transform quantized data and the transform-skipping quantized data, codes the acquired parameters (syntax elements), and causes the accumulation buffer 29 to accumulate therein the coding results (being multiplexed) as part of header information.

The accumulation buffer 29 temporarily retains therein the coded data supplied from the entropy coding part 28 and outputs the coded data at a predetermined timing as a coded stream to, for example, a recording apparatus, a transmission path, and the like in the subsequent stage and which are not depicted.

The rate control part 30 controls the rate of the quantization operations of the quantizing parts 15 and 16 on the basis of compressed images accumulated in the accumulation buffer 29 so as to prevent generation of an overflow or an underflow.

The inverse-quantizing part 31 inverse-quantizes the transform quantized data supplied from the quantizing part 15 using a method corresponding to the quantization executed by the quantizing part 15. The inverse-quantizing part 31 outputs the acquired inverse-quantized data, that is, the transform coefficient to the inverse-orthogonal transforming part 32.

The inverse-orthogonal transforming part 32 inverse-orthogonal transforms the transform coefficient supplied from the inverse-quantizing part 31 using a method corresponding to the orthogonal transform process executed by the orthogonal transforming part 14. The inverse-orthogonal transforming part 32 outputs the inverse orthogonal transform result, that is, decoded residual data to the computing part 34.

The inverse-quantizing part 33 inverse-quantizes the transform-skipping quantized data supplied from the quantizing part 16 using a method corresponding to the quantization executed by the quantizing part 16. The inverse-quantizing part 33 outputs the acquired inverse-quantized data, that is, the residual data to the computing part 34.

The computing part 34 adds the residual data supplied from the inverse-orthogonal transforming part 32 and the residual data supplied from the inverse-quantizing part 33 to each other and outputs the addition result to the computing part 41 as decoded residual data.

The computing part 41 adds the predicted image data to be supplied from the intra predicting part 45 or the motion predicting and compensating part 46 through the prediction selecting part 47 to the decoded residual data supplied from the computing part 34 to acquire decoded image data that is locally decoded. The computing part 41 outputs the decoded image data to the in-loop filter 42. Moreover, the computing part 41 outputs the decoded image data to the frame memory 43 as reference image data.

The in-loop filter 42 includes at least any of, for example, a deblocking filter, an adaptive offset filter, or an adaptive loop filter. The in-loop filter 42 executes a filtering process for the decoded image data and outputs the decoded image data after the filtering process to the frame memory 43 as reference image data. Moreover, the in-loop filter 42 outputs the parameters relating to the filtering process to the entropy coding part 28.

The reference image data accumulated in the frame memory 43 is output at a predetermined timing to the intra predicting part 45 or the motion predicting and compensating part 46 through the selecting part 44.

The intra predicting part 45 executes intra prediction (in-screen prediction) that produces a predicted image using the pixel value in the screen. The intra predicting part 45 produces the predicted image data for each of all the intra prediction modes, using the decoded image data produced by the computing part 41 and stored in the frame memory 43, as the reference image data. Moreover, the intra predicting part 45 executes calculation and the like of the cost of each of the intra prediction modes using the original image data supplied from the screen sorting buffer 11 and the predicted image data, and selects the optimal mode in which the calculated cost becomes minimal. The intra predicting part 45 outputs the predicted image data in the selected intra prediction mode, parameters such as intra prediction mode information indicating the selected intra prediction mode, the cost, and the like to the prediction selecting part 47.

For the image to be inter-coded, the motion predicting and compensating part 46 executes motion prediction using the original image data supplied from the screen sorting buffer 11 and the decoded image data which is filtered and is then stored in the frame memory 43, as the reference image data. Moreover, the motion predicting and compensating part 46 executes a motion compensation process in accordance with the motion vector detected by the motion prediction to produce the predicted image data.

The motion predicting and compensating part 46 executes an inter prediction process in all the inter prediction modes as candidates, executes calculation and the like of the cost by producing the predicted image data for each of all the intra prediction modes, and selects the optimal mode in which the calculated cost becomes optimal. The motion predicting and compensating part 46 outputs the predicted image data of the selected inter prediction mode, the parameters such as the inter prediction mode information indicating the selected inter prediction mode, motion vector information indicating the calculated motion vector, the cost, and the like to the prediction selecting part 47.

The prediction selecting part 47 selects the optimal prediction process on the basis of the costs of the intra prediction mode and the inter prediction mode. In a case where the prediction selecting part 47 selects the intra prediction process, the prediction selecting part 47 outputs the predicted image data supplied from the intra predicting part 45 to the computing part 12 and the computing part 41, and outputs the parameters such as the intra prediction mode information and the like to the entropy coding part 28. In a case where the prediction selecting part 47 selects the inter prediction process, the prediction selecting part 47 outputs the predicted image data supplied from the motion predicting and compensating part 46 to the computing part 12 and the computing part 41, and outputs the parameters such as the inter prediction mode information, the motion vector information, and the like to the entropy coding part 28.

### 2-4-2. Operations of Image Coding Apparatus

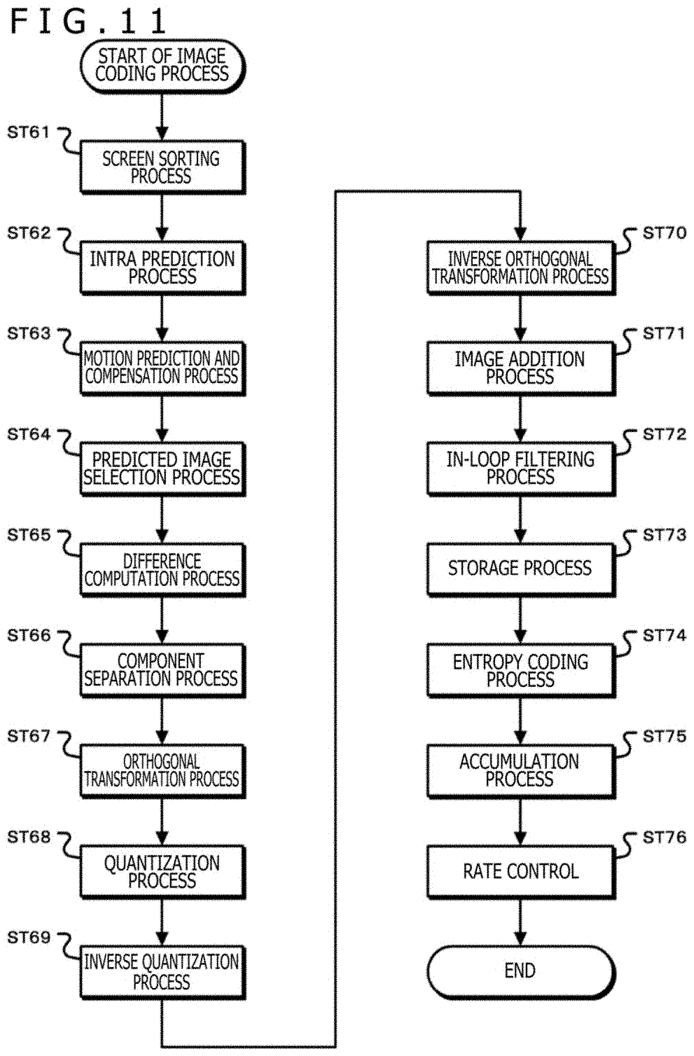

Operations of the fourth embodiment of the image coding apparatus will next be described. FIG. 11 is a flowchart exemplifying operations of the image coding apparatus. In addition, step ST61 to step ST65 and step ST66 to step ST76 correspond to step ST1 to step ST15 of the first embodiment depicted in FIG. 2.

At step ST61, the image coding apparatus executes the screen sorting process. The screen sorting buffer 11 of the image coding apparatus 10-4 sorts the frame images in the display order into those in coding order and outputs these to the intra predicting part 45 and the motion predicting and compensating part 46.

At step ST62, the image coding apparatus executes the intra prediction process. The intra predicting part 45 of the image coding apparatus 10-4 outputs the predicted image data produced in the optimal intra prediction mode, the parameters, and the cost to the prediction selecting part 47.

At step ST63, the image coding apparatus executes the motion predicting and compensating process. The motion predicting and compensating part 46 of the image coding apparatus 10-4 outputs the predicted image data produced using the optimal inter prediction mode, the parameters, and the cost to the prediction selecting part 47.

At step ST64, the image coding apparatus executes a predicted image selection process. the prediction selecting part 47 of the image coding apparatus 10-4 determines one of the optimal intra prediction mode and the optimal inter prediction mode as the optimal prediction mode on the basis of the costs calculated at step ST62 and step ST63. The prediction selecting part 47 next selects the predicted image data of the determined optimal prediction mode and outputs the selected predicted image data to the computing parts 12 and 41.

At step ST65, the image coding apparatus executes the difference computation process. The computing part 12 of the image coding apparatus 10-4 calculates the difference between the original image data sorted at step ST61 and the predicted image data selected at step ST64, and outputs the residual data that is the differential result to the filtering part 13.

At step ST66, the image coding apparatus executes a component separation process. The filtering part 13 of the image coding apparatus 10-4 executes the component separation process for the residual data supplied from the computing part 12, outputs first separation data to the orthogonal transforming part 14, and outputs second separation data to the quantizing part 16.

At step ST67, the image coding apparatus executes an orthogonal transform process. The orthogonal transforming part 14 of the image coding apparatus 10-4 orthogonal-transforms the first separation data acquired by the component separation process at step ST66. More specifically, the orthogonal transforming part 14 executes an orthogonal transform such as a discrete cosine transform or a Karhunen-Loeve transform, and outputs the acquired transform coefficient to the quantizing part 15.

At step ST68, the image coding apparatus executes a quantization process. The quantizing part 15 of the image coding apparatus 10-4 quantizes the transform coefficient supplied from the orthogonal transforming part 14 to produce transform quantized data. The quantizing part 15 outputs the produced transform quantized data to the entropy coding part 28 and the inverse-quantizing part 31. Moreover, the quantizing part 16 quantizes the second separation data supplied from the filtering part 13 as the transform-skipping coefficient acquired by executing the transform-skipping process to produce transform-skipping quantized data. The quantizing part 16 outputs the produced transform-skipping quantized data to the entropy coding part 28 and the inverse-quantizing part 33. In this quantization, the rate control is executed as described in the process at step ST76 described later.

At step ST68, the image coding apparatus executes a quantization process. The quantizing part 15 of the image coding apparatus 10-4 quantizes the transform coefficient supplied from the orthogonal transforming part 14 to produce transform quantized data. The quantizing part 15 outputs the produced transform quantized data to the entropy coding part 28 and the inverse-quantizing part 31. Moreover, the quantizing part 16 quantizes the second separation data supplied from the filtering part 13 as the transform-skipping coefficient acquired by executing the transform-skipping process to produce the transform-skipping quantized data. The quantizing part 16 outputs the produced transform-skipping quantized data to the entropy coding part 28 and the inverse-quantizing part 33. In this quantization, the rate control is executed as described in the process at step ST76 described later.

The quantized data produced as above is locally decoded in the manner as below. In other words, at step ST69, the image coding apparatus executes an inverse-quantization process. The inverse-quantizing part 31 of the image coding apparatus 10-4 inverse-quantizes the transform quantized data output from the quantizing part 15 using a property corresponding to the quantizing part 15. Moreover, the inverse-quantizing part 33 of the image coding apparatus 10-4 inverse-quantizes the transform-skipping quantized data output from the quantizing part 16 using a property corresponding to the quantizing part 16 to acquire residual data.

At step ST70, the image coding apparatus executes an inverse-orthogonal transform process. The inverse-orthogonal transforming part 32 of the image coding apparatus 10-4 inverse-orthogonal transforms the inverse quantized data acquired by the inverse-quantizing part 31, that is, the transform coefficient using a property corresponding to the orthogonal transforming part 14 to produce the residual data.

At step ST71, the image coding apparatus executes an image addition process. The computing part 34 of the image coding apparatus 10-4 adds the residual data acquired by executing the inverse quantization by the inverse-quantizing part 33 at step ST69 and the residual data acquired by executing the inverse orthogonal transform by the inverse-orthogonal transforming part 32 at step ST70 to each other. Moreover, the computing part 41 adds the locally decoded residual data and the predicted image data selected at step ST65 to each other to produce decoded image data that is locally decoded.

At step ST72, the image coding apparatus executes an in-loop filtering process. The in-loop filter 42 of the image coding apparatus 10-4 executes at least any filtering process of, for example, a deblocking filtering process, the SAO process, or the adaptive loop filtering process, for the decoded image data produced by the computing part 41, and outputs the decoded image data after the filtering process to the frame memory 43.

At step ST73, the image coding apparatus executes a storage process. The frame memory 43 of the image coding apparatus 10-4 stores therein the decoded image data after the in-loop filtering process at step ST72 and the decoded image data before the in-loop filtering process, as reference image data.

At step ST74, the image coding apparatus executes an entropy coding process. The entropy coding part 28 of the image coding apparatus 10-4 codes the transform quantized data and the transform-skipping quantized data respectively supplied from the quantizing parts 15 and 25, the parameters supplied from the in-loop filter 42 and the prediction selecting part 47, and the like.

At step ST75, the image coding apparatus executes an accumulation process. The accumulation buffer 29 of the image coding apparatus 10-4 accumulates therein the coded data. The coded data accumulated in the accumulation buffer 29 is appropriately read and is transmitted to the decoding side through a transmission path or the like.

At step ST76, the image coding apparatus executes rate control. The rate control part 30 of the image coding apparatus 10-4 executes rate control for the quantization operation of each of the quantizing parts 15 and 25 so as to prevent generation of an overflow or an underflow of the coded data accumulated in the accumulation buffer 29.

According to the above fourth embodiment, the residual data is divided into the frequency band for the orthogonal transform and the frequency band for the transform skipping, and the production of the orthogonal transform coefficient and that of the transform-skipping coefficient are concurrently executed. Therefore, even in a case where the quantized data of the orthogonal transform coefficient and that of the transform-skipping coefficient are included in the coded stream, the coding process can be executed at a high speed. Moreover, when the component separation process by the filtering part is optimized, any generation of ringing and banding in the decoded image can be suppressed.

### 3. Regarding Image Decoding Apparatus

### 3-1. First Embodiment

In a first embodiment of an image decoding apparatus, decoding of the coded stream produced by the above image coding apparatus is executed, and the quantized data of the transform coefficient and the quantized data of the transform-skipping coefficient are simultaneously acquired. Moreover, the image processing apparatus concurrently executes the inverse quantization for the acquired transform coefficient, inverse orthogonal transform, and the inverse quantization for the acquired transform-skipping coefficient to produce pieces of image data on the basis of the transform coefficient and the transform-skipping coefficient, and executes a computing process using the pieces of produced image data to produce decoded image data.

### 3-1-1. Configuration of Image Decoding Apparatus

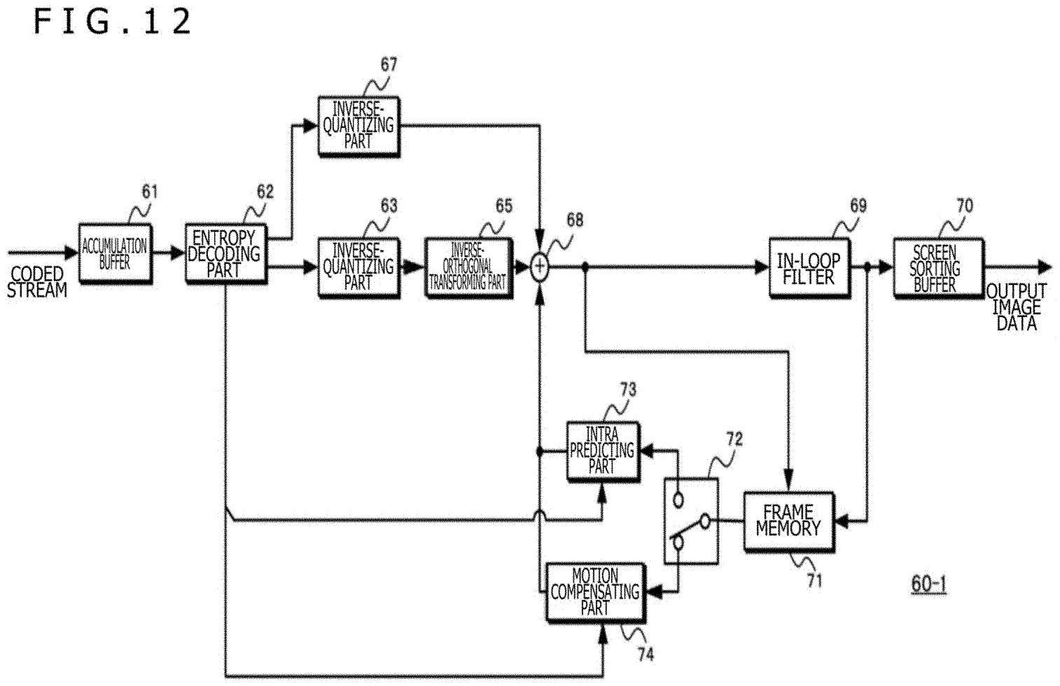

FIG. 12 exemplifies a configuration of the first embodiment of an image decoding apparatus. The coded stream produced by the image coding apparatus is supplied to the image decoding apparatus 60-1 through a predetermined transmission path, a predetermined recoding medium, or the like to be decoded.

The image decoding apparatus 60-1 includes an accumulation buffer 61, an entropy decoding part 62, inverse-quantizing parts 63 and 67, an inverse-orthogonal transforming part 65, a computing part 68, an in-loop filter 69, and a screen sorting buffer 70. Moreover, the image decoding apparatus 60-1 includes a frame memory 71, a selecting part 72, an intra predicting part 73, and a motion compensating part 74.

The accumulation buffer 61 receives a transmitted coded stream such as, for example, the coded stream produced by the image coding apparatus depicted in FIG. 1 and accumulates therein the coded stream. The coded stream is read at a predetermined timing and is output to the entropy decoding part 62.

The entropy decoding part 62 entropy-decodes the coded stream, outputs parameters such as information indicating an acquired intra prediction mode to the intra predicting part 73, and outputs parameters such as information indicating the inter prediction mode and motion vector information to the motion compensating part 74. Moreover, the entropy decoding part 62 outputs parameters relating to a filter to the in-loop filter 69. Furthermore, the entropy decoding part 62 outputs the transform quantized data and parameters relating to the transform quantized data to the inverse-quantizing part 63, and outputs differential quantized data and parameters relating to the differential quantized data to the inverse-quantizing part 67.

The inverse-quantizing part 63 inverse-quantizes the transform quantized data decoded by the entropy decoding part 62 using a scheme corresponding to the quantization scheme of the quantizing part 15 in FIG. 1 using the decoded parameters. The inverse-quantizing part 63 outputs the transform coefficient acquired by the inverse quantization to the inverse-orthogonal transforming part 65.

The inverse-quantizing part 67 inverse-quantizes the transform-skipping quantized data decoded by the entropy decoding part 62 using a scheme corresponding to the quantization scheme of the quantizing part 16 depicted in FIG. 1 using the decoded parameters. The inverse-quantizing part 67 outputs the decoded residual data that is the transform-skipping coefficient acquired by the inverse quantization to the computing part 68.

The inverse-orthogonal transforming part 65 executes inverse orthogonal transform using a scheme corresponding to the orthogonal transform scheme of the orthogonal transforming part 14 in FIG. 1 to acquire decoded residual data that corresponds to the residual data before the orthogonal transform in the image coding apparatus, and outputs the decoded residual data to the computing part 68.

To the computing part 68, the predicted image data is supplied from the intra predicting part 73 or the motion compensating part 74. The computing part 68 adds the decoded residual data and the predicted image data to each other that are respectively supplied from the inverse-orthogonal transforming part 65 and the inverse-quantizing part 67 to acquire decoded image data corresponding to the original image data before the predicted image data is subtracted therefrom by the computing part 12 of the image coding apparatus. The computing part 68 outputs the decoded image data to the in-loop filter 69 and the frame memory 71.

The in-loop filter 69 executes at least any of the deblocking filtering process, the SAO process, or the adaptive loop filtering process using the parameters to be supplied from the entropy decoding part 62 in the similar manner as that of the in-loop filter 42 of the image coding apparatus, and outputs the filtering process result to the screen sorting buffer 70 and the frame memory 71.

The screen sorting buffer 70 executes sorting of the images. In other words, the screen sorting buffer 70 sorts the order of the frames sorted for the order of the coding by the screen sorting buffer 11 of the image coding apparatus into the original display order to produce output image data.

The frame memory 71, the selecting part 72, the intra predicting part 73, and the motion compensating part 74 respectively correspond to the frame memory 43, the selecting part 44, the intra predicting part 45, and the motion predicting and compensating part 46 of the image coding apparatus.

The frame memory 71 stores therein the decoded image data supplied from the computing part 68 and the decoded image data supplied from the in-loop filter 69 as reference image data.

The selecting part 72 reads the reference image data to be used in the intra prediction from the frame memory 71 and outputs the reference image data to the intra predicting part 73. Moreover, the selecting part 72 reads the reference image data to be used in inter prediction from the frame memory 71 and outputs the reference image data to the motion compensating part 74.

To the intra predicting part 73, information indicating the intra prediction mode acquired by decoding the header information, and the like are appropriately supplied from the entropy decoding part 62. The intra predicting part 73 produces predicted image data from the reference image data acquired from the frame memory 71 on the basis of the above information and outputs the predicted image data to the computing part 68.

To the motion compensating part 74, the information acquired by decoding the header information (such as prediction mode information, motion vector information, reference frame information, a flag, and various types of parameters) is supplied from the entropy decoding part 62. The motion compensating part 74 produces the predicted image data from the reference image data acquired from the frame memory 71 on the basis of those pieces of information supplied from the entropy decoding part 62, and outputs the predicted image data to the computing part 68.

### 3-1-2. Operations of Image Decoding Apparatus

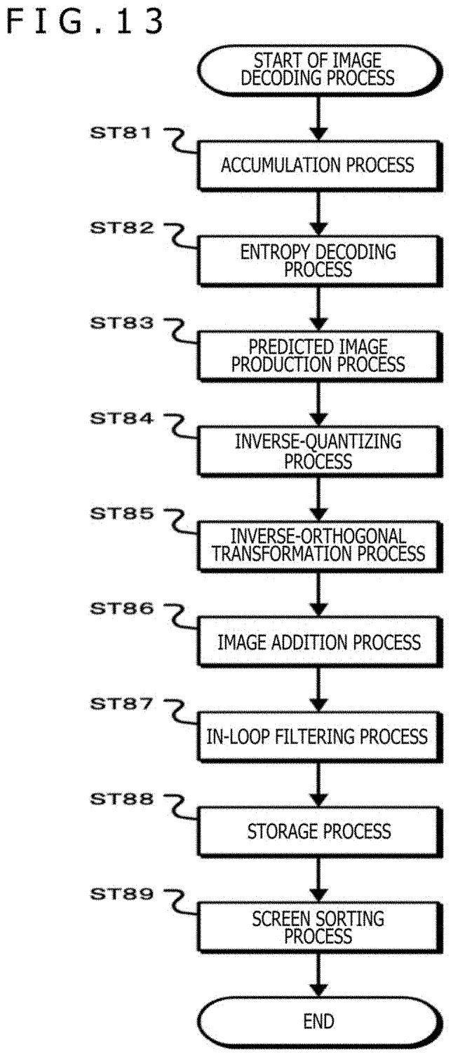

Operations of the first embodiment of the image decoding apparatus will next be described. FIG. 13 is a flowchart exemplifying the operations of the image decoding apparatus.

When the decoding process is started, at step ST81, the image decoding apparatus executes an accumulation process. The accumulation buffer 61 of the image decoding apparatus 60-1 receives and accumulates therein the coded stream.

At step ST82, the image decoding apparatus executes an entropy decoding process. The entropy decoding part 62 of the image decoding apparatus 60-1 acquires the coded stream from the accumulation buffer 61 and executes a decoding process for the coded stream to decode an I-picture, a P-picture, and a B-picture that are coded by the entropy coding process by the image coding apparatus. Moreover, prior to decoding the pictures, the entropy decoding part 62 also decodes motion vector information, reference frame information, prediction mode information (the intra prediction mode or the inter prediction mode), and information regarding the parameters for an in-loop filtering process and the like. In a case where the prediction mode information is the intra prediction mode information, the prediction mode information is output to the intra predicting part 73. In a case where the prediction mode information is the inter prediction mode information, the motion vector information and the like corresponding to the prediction mode information are output to the motion compensating part 74. Moreover, parameters relating to the in-loop filtering process are output to the in-loop filter 69. Information regarding the quantization parameters are output to the inverse-quantizing parts 63 and 67.

At step ST83, the image decoding apparatus executes a predicted image production process. The intra predicting part 73 or the motion compensating part 74 of the image decoding apparatus 60-1 each execute a predicted image production process corresponding to the prediction mode information to be supplied from the entropy decoding part 62.

In other words, in a case where the intra prediction mode information is supplied from the entropy decoding part 62, the intra predicting part 73 produces the intra predicted image data of the intra prediction mode using the reference image data stored in the frame memory 71. In a case where the inter prediction mode information is supplied from the entropy decoding part 62, the motion compensating part 74 executes a motion compensation process for the inter prediction mode using the reference image data stored in the frame memory 71 to produce the inter predicted image data. The intra predicted image data produced by the intra predicting part 73 or the inter predicted image data produced by the motion compensating part 74 is output through this process to the computing part 68.

At step ST84, the image decoding apparatus executes an inverse quantization process. The inverse-quantizing part 63 of the image decoding apparatus 60-1 inverse-quantizes the transform quantized data acquired by the entropy decoding part 62 using a scheme corresponding to the quantization process of the image coding apparatus using the decoded parameters, and outputs the acquired transform coefficient to the inverse-orthogonal transforming part 65. Moreover, the inverse-quantizing part 67 inverse-quantizes the transform-skipping quantized data acquired by the entropy decoding part 62 using a scheme corresponding to the quantization process by the image coding apparatus using the decoded parameters, and outputs the acquired transform-skipping coefficient, that is, decoded residual data to the computing part 68.

At step ST85, the image decoding apparatus executes an inverse orthogonal transform process. The inverse-orthogonal transforming part 65 of the image decoding apparatus 60-1 executes an inverse orthogonal transform process for the inverse-quantized data, that is, the transform coefficient supplied from the inverse-quantizing part 63 using a scheme corresponding to the orthogonal transform process by the image coding apparatus to acquire decoded residual data corresponding to the residual data before the orthogonal transform in the image coding apparatus and outputs the decoded residual data to the computing part 68.

At step ST86, the image decoding apparatus executes an image addition process. The computing part 68 of the image decoding apparatus 60-1 adds the predicted image data supplied from the intra predicting part 73 or the motion compensating part 74, the decoded residual data supplied from the inverse-orthogonal transforming part 65, and the residual data supplied from the inverse-quantizing part 67 to each other to produce decoded image data. The computing part 68 outputs the produced decoded image data to the in-loop filter 69 and the frame memory 71.

At step ST87, the image decoding apparatus executes an in-loop filtering process. The in-loop filter 69 of the image decoding apparatus 60-1 executes at least any of the deblocking filtering process, the SAO process, or the adaptive in-loop filtering process, for the decoded image data output from the computing part 68 in the similar manner as that of the in-loop filtering process of the image coding apparatus. The in-loop filter 69 outputs the decoded image data after the filtering process to the screen sorting buffer 70 and the frame memory 71.

At step ST88, the image decoding apparatus executes a storage process. The frame memory 71 of the image decoding apparatus 60-1 stores therein the decoded image data before the filtering process supplied from the computing part 68 and the decoded image data which is filtered by the in-loop filter 69, as reference image data.

At step ST89, the image decoding apparatus executes a screen sorting process. The screen sorting buffer 70 of the image decoding apparatus 60-1 accumulates the decoded image data supplied from the in-loop filter 69, reconstitutes the accumulated image data into that in the display order before the sorting by the screen sorting buffer 11 of the image coding apparatus, and outputs the decoded image data as output image data.

As above, in the first embodiment, the decoding process can be executed for the coded stream that includes, for example, the transform coefficient and the transform-skipping coefficient, and degradation of the high image quality of the decoded image can therefore be suppressed compared to a case where the decoding process is executed for the coded stream that includes either the transform coefficient or the transform-skipping coefficient.

### 3-2. Second Embodiment

In a second embodiment of the image decoding apparatus, decoding is executed for the coded stream produced by the above image coding apparatus and inverse quantization processes are executed sequentially for the quantized data of the transform coefficient and quantized data of the transform-skipping coefficient. Moreover, inverse orthogonal transform is executed for the transform coefficient acquired by executing the inverse quantization. Furthermore, one of the image data produced by executing the inverse quantization for the quantized data of the transform-skipping coefficient or the image data produced by executing the inverse-orthogonal transform for the transform coefficient is temporarily stored in a buffer, and then, the stored image data is used in synchronization with the other image date to execute a computing process, thereby producing the decoded image data. In addition, the second embodiment exemplifies a case where the inverse quantization is executed for the quantized data of the transform coefficient after the inverse quantization of the quantized data of the transform-skipping coefficient and the image data produced by the inverse quantization for the transform-skipping coefficient is stored in the buffer. Moreover, configurations corresponding to those of the first embodiment are given the same reference signs.

### 3-2-1. Configuration of Image Decoding Apparatus

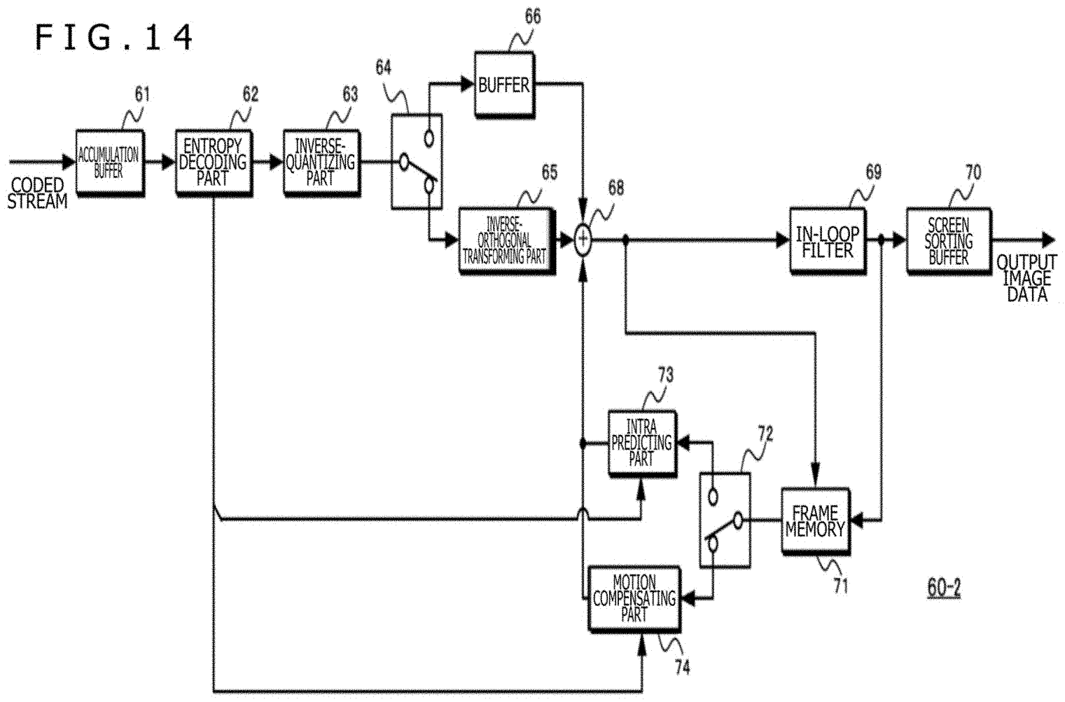

FIG. 14 exemplifies a configuration of the second embodiment of the image decoding apparatus. The coded stream produced by the above image coding apparatus is supplied to an image decoding apparatus 60-2 through a predetermined transmission path, a predetermined recording medium, or the like to be decoded.

The image decoding apparatus 60-2 includes the accumulation buffer 61, the entropy decoding part 62, the inverse-quantizing part 63, the selecting part 64, the inverse-orthogonal transforming part 65, a buffer 66, the computing part 68, the in-loop filter 69, and the screen sorting buffer 70. Moreover, the image decoding apparatus 60-2 includes the frame memory 71, the selecting part 72, the intra predicting part 73, and the motion compensating part 74.

The accumulation buffer 61 receives a transmitted coded stream, for example, the coded stream produced by the image coding apparatus depicted in FIG. 3 and accumulates therein the coded stream. The coded stream is read at a predetermined timing and is output to the entropy decoding part 62.

The entropy decoding part 62 entropy-decodes the coded stream, outputs parameters such as information indicating an acquired intra prediction mode to the intra predicting part 73, and outputs parameters such as information indicating the inter prediction mode and motion vector information to the motion compensating part 74. Moreover, the entropy decoding part 62 outputs parameters relating to a filter to the in-loop filter 69. Furthermore, the entropy decoding part 62 outputs the transform quantized data and parameters relating to the transform quantized data to the inverse-quantizing part 63.

The inverse-quantizing part 63 inverse-quantizes the transform quantized data decoded by the entropy decoding part 62 using a scheme corresponding to the quantization scheme of the quantizing part 15 in FIG. 3 using the decoded parameters. Moreover, the inverse-quantizing part 63 inverse-quantizes the transform-skipping quantized data decoded by the entropy decoding part 62, using a scheme corresponding to the quantization scheme of the quantizing part 25 in FIG. 3 using the decoded parameters. The inverse-quantizing part 63 outputs the transform coefficient and the transform-skipping coefficient each acquired by the inverse quantization to the selecting part 64.

The selecting part 64 outputs the transform coefficient acquired by the inverse quantization to the inverse-orthogonal transforming part 65. Moreover, the selecting part 64 outputs the transform-skipping coefficient, that is, the transform error data acquired by the inverse quantization to the buffer 66.

The inverse-orthogonal transforming part 65 executes inverse orthogonal transform for the transform coefficient using a scheme corresponding to the orthogonal transform scheme of the orthogonal transforming part 14 in FIG. 3 and then outputs the acquired residual data to the computing part 68.

To the computing part 68, the predicted image data is supplied from the intra predicting part 73 or the motion compensating part 74. Moreover, to the computing part 68, the residual data is supplied from the inverse-orthogonal transforming part 65, and the transform error data is supplied from the buffer 66. The computing part 68 adds the residual data, the transform error data, and the predicted image data to each other for each pixel to acquire the decoded image data that corresponds to the original image data before the subtraction of the predicted image data therefrom by the computing part 12 of the image coding apparatus. The computing part 68 outputs the decoded image data to the in-loop filter 69 and the frame memory 71.

The in-loop filter 69 executes at least any of the deblocking filtering process, the SAO process, or the adaptive loop filtering process, using the parameters supplied from the entropy decoding part 62 in the similar manner as the in-loop filter 42 of the image coding apparatus, and outputs the filtering process result to the screen sorting buffer 70 and the frame memory 71.

The screen sorting buffer 70 executes sorting of the images. In other words, the screen sorting buffer 70 sorts the order of the frames sorted for the order of the coding by the screen sorting buffer 11 of the image coding apparatus into the original display order to produce output image data.

The frame memory 71, the selecting part 72, the intra predicting part 73, and the motion compensating part 74 respectively correspond to the frame memory 43, the selecting part 44, the intra predicting part 45, and the motion predicting and compensating part 46 of the image coding apparatus.

The frame memory 71 stores therein the decoded image data supplied from the computing part 68 and the decoded image data supplied from the in-loop filter 69, as reference image data.

The selecting part 72 reads the reference image data to be used in the intra prediction from the frame memory 71 and outputs the reference image data to the intra predicting part 73. Moreover, the selecting part 72 reads the reference image data to be used in inter prediction from the frame memory 71 and outputs the reference image data to the motion compensating part 74.

To the intra predicting part 73, information indicating the intra prediction mode acquired by decoding the header information, and the like are appropriately supplied from the entropy decoding part 62. On the basis of this information, the intra predicting part 73 produces the predicted image data from the reference image data acquired from the frame memory 71, and outputs the produced predicted image data to the computing part 68.

To the motion compensating part 74, the information acquired by decoding the header information (such as prediction mode information, motion vector information, reference frame information, a flag, and various types of parameters) is supplied from the entropy decoding part 62. The motion compensating part 74 produces the predicted image data from the reference image data acquired from the frame memory 71 on the basis of those pieces of information to be supplied from the entropy decoding part 62, and outputs the predicted image data to the computing part 68.

### 3-2-2. Operations of Image Decoding Apparatus

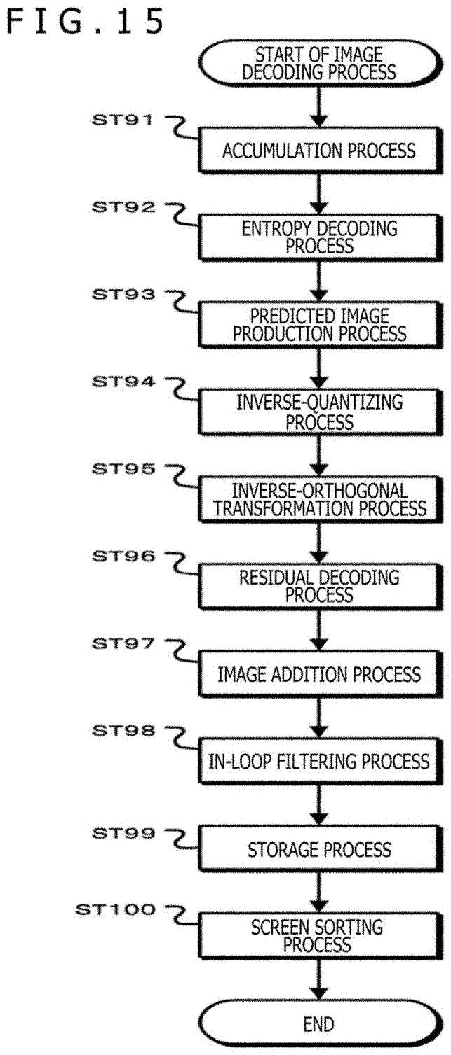

Operations of the second embodiment of the image decoding apparatus will next be described. FIG. 15 is a flowchart exemplifying the operations of the image decoding apparatus.

When the decoding process is started, at step ST91, the image decoding apparatus executes an accumulation process. The accumulation buffer 61 of the image decoding apparatus 60-2 receives and accumulates therein the coded stream.

At step ST92, the image decoding apparatus executes an entropy decoding process. The entropy decoding part 62 of the image decoding apparatus 60-2 acquires the coded stream from the accumulation buffer 61 and executes the decoding process for the coded stream to decode an I-picture, a P-picture, and a B-picture that are coded by the entropy coding process of the image coding apparatus. Moreover, prior to decoding the pictures, the entropy decoding part 62 also decodes motion vector information, reference frame information, prediction mode information (the intra prediction mode or the inter prediction mode), and information regarding the parameters for the in-loop filtering process and the like. In a case where the prediction mode information is the intra prediction mode information, the prediction mode information is output to the intra predicting part 73. In a case where the prediction mode information is the inter prediction mode information, the motion vector information and the like corresponding to the prediction mode information are output to the motion compensating part 74. Moreover, the parameters relating to the in-loop filtering process are output to the in-loop filter 69. Information regarding the quantization parameters is output to the inverse-quantizing part 63.

At step ST93, the image decoding apparatus executes a predicted image production process. The intra predicting part 73 or the motion compensating part 74 of the image decoding apparatus 60-2 each execute the predicted image production process corresponding to the prediction mode information supplied from the entropy decoding part 62.

In other words, in a case where the intra prediction mode information is supplied from the entropy decoding part 62, the intra predicting part 73 produces the intra predicted image data of the intra prediction mode using the reference image data stored in the frame memory 71. In a case where the inter prediction mode information is supplied from the entropy decoding part 62, the motion compensating part 74 executes a motion compensation process of the inter prediction mode using the reference image data stored in the frame memory 71 to produce the inter predicted image data. The predicted image data produced by the intra predicting part 73 or the predicted image data produced by the motion compensating part 74 is output through this process to the computing part 68.

At step ST94, the image decoding apparatus executes an inverse quantization process. The inverse-quantizing part 63 of the image decoding apparatus 60-2 inverse-quantizes the transform quantized data acquired by the entropy decoding part 62 using a scheme corresponding to the quantization process of the image coding apparatus using the decoded parameters, and outputs the acquired transform coefficient to the inverse-orthogonal transforming part 65. Moreover, the inverse-quantizing part 67 inverse-quantizes the transform-skipping quantized data acquired by the entropy decoding part 62 using a scheme corresponding to the quantization process of the image coding apparatus using the decoded parameters, and outputs the acquired transform-skipping coefficient, that is, decoded transform error data to the computing part 68.

At step ST95, the image decoding apparatus executes an inverse orthogonal transform process. The inverse-orthogonal transforming part 65 of the image decoding apparatus 60-2 executes an inverse orthogonal transform process for the inverse-quantized data, that is, the transform coefficient supplied from the inverse-quantizing part 63 using a scheme corresponding to the orthogonal transform process of the image coding apparatus to acquire residual data, and outputs the residual data to the computing part 68.

At step ST96, the image decoding apparatus executes a residual decoding process. The computing part 68 of the image decoding apparatus 60-2 adds the residual data supplied from the inverse-orthogonal transforming part 65 and the transform error data supplied from the buffer 66 to each other for each pixel to produce decoded residual data that corresponds to the residual data before the orthogonal transform in the image coding apparatus.

At step ST97, the image decoding apparatus executes an image addition process. The computing part 68 of the image decoding apparatus 60-2 adds the predicted image data supplied from the intra predicting part 73 or the motion compensating part 74 and the decoded residual data produced at step ST96 to each other to produce the decoded image data. The computing part 68 outputs the produced decoded image data to the in-loop filter 69 and the frame memory 71.

At step ST98, the image decoding apparatus executes an in-loop filtering process. The in-loop filter 69 of the image decoding apparatus 60-2 executes at least any of the deblocking filtering process, the SAO process, or the adaptive in-loop filtering process, for the decoded image data output from the computing part 68 in the similar manner as the in-loop filtering process of the image coding apparatus. The in-loop filter 69 outputs the decoded image data after the filtering process to the screen sorting buffer 70 and the frame memory 71.

At step ST99, the image decoding apparatus executes a storage process. The frame memory 71 of the image decoding apparatus 60-2 stores therein the decoded image data before the filtering process supplied from the computing part 68 and the decoded image data which is filtered by the in-loop filter 69, as reference image data.

At step ST100, the image decoding apparatus executes a screen sorting process. The screen sorting buffer 70 of the image decoding apparatus 60-2 accumulates therein the decoded image data supplied from the in-loop filter 69, reconstitutes the accumulated decoded image data into that in the display order before the sorting by the screen sorting buffer 11 of the image coding apparatus, and outputs the decoded image data as output image data.

Moreover, though not depicted, in a case where the inverse quantization of the quantized data of the transform-skipping coefficient is executed after the inverse quantization of the quantized data of the transform coefficient, the image data produced by the inverse-orthogonal transforming part 65 is temporarily stored in the buffer, and then, the stored image data is used in synchronization with the image data produced by executing the inverse quantization for the transform-skipping coefficient to execute a computation process, thereby producing decoded image data.

As above, in the second embodiment, the decoding process can be executed for the coded stream that includes the transform coefficient and the transform-skipping coefficient, and degradation of the high image quality of the decoded image can therefore be suppressed compared to a case where the decoding process is executed for the coded stream that includes either the transform coefficient or the transform-skipping coefficient. Moreover, the decoded image can be produced even in a case where the quantized data of the transform coefficient and the quantized data of the transform-skipping coefficient cannot simultaneously be acquired and inverse quantization and inverse orthogonal transform of the acquired transform coefficient and inverse quantization of the acquired transform-skipping coefficient cannot concurrently be executed.

### 4. Exemplary Operations of Image Processing Apparatus

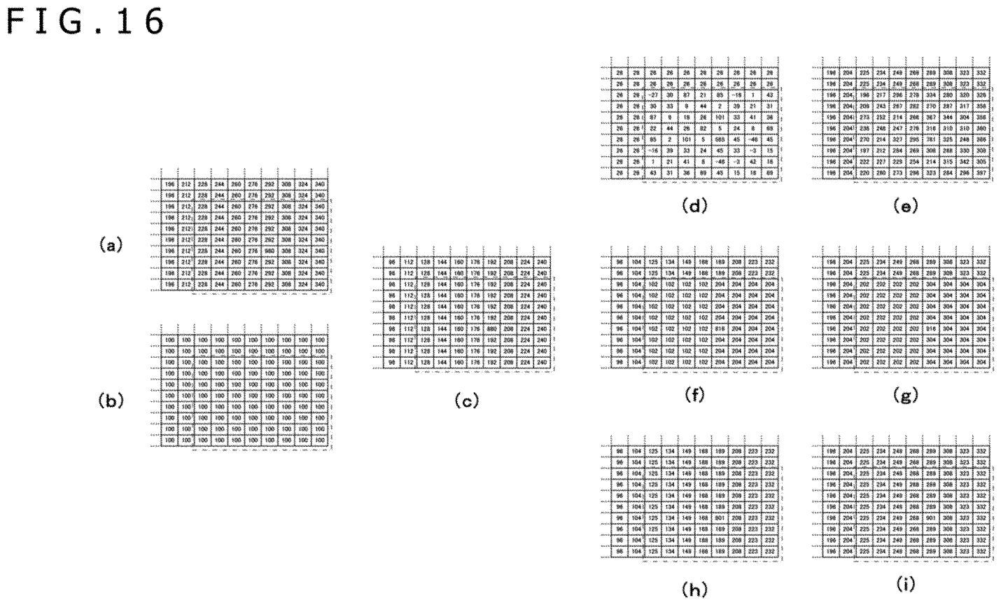

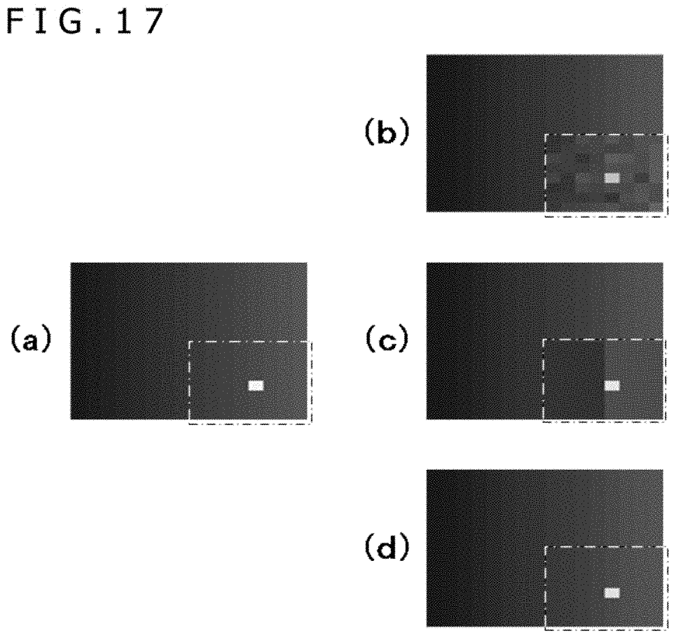

Exemplary operations of an image processing apparatus will next be described. FIG. 16 depicts exemplary operations. (a) of FIG. 16 exemplifies the original image data and (b) of FIG. 16 exemplifies the predicted image data. Moreover, (c) of FIG. 16 depicts the residual data. FIG. 17 exemplifies original images and decoded images, (a) of FIG. 17 is the original image corresponding to the original image data depicted in (a) of FIG. 16.

When a decoding process is executed for the coded stream produced by executing the coding process for the residual data using the orthogonal transform, the decoded residual data depicted in (d) of FIG. 16 can be acquired. The decoded image data depicted in (e) of FIG. 16 is acquired by adding the predicted image data to this decoded residual data. Note that (b) of FIG. 17 is the decoded image corresponding to the decoded image data depicted in (e) of FIG. 16.

Moreover, when a decoding process is executed for the coded stream produced by executing the coding process for the residual data using the transform skipping, the decoded residual data depicted in (f) of FIG. 16 can be acquired. The decoded image data depicted in (g) of FIG. 16 is acquired by adding the predicted image data to this decoded residual data. Note that (c) of FIG. 17 is the decoded image corresponding to the decoded image data depicted in (g) of FIG. 16.

Concerning the above, in a case where the coefficient included in the coded stream is only the transform coefficient, as depicted in (e) of FIG. 16 and (b) of FIG. 17, no impulse can be reproduced in the decoding, and a mosquito noise is generated. Moreover, in a case where the coefficient included in the coded stream are only the transform-skipping coefficient, as depicted in (g) of FIG. 16 and (c) of FIG. 17, impulse can be reproduced in the decoding while no gradation can accurately be reproduced.

In contrast, in the present technique, the transform coefficient and the transform-skipping coefficient are included in the coded stream. The decoded residual data depicted in (h) of FIG. 16 can therefore be acquired when the decoding process is executed for the coded stream. The decoded image data depicted in (i) of FIG. 16 is acquired by adding the predicted image data to this decoded residual data. In addition, (d) of FIG. 17 is the decoded image corresponding to the decoded image data depicted in (i) of FIG. 16. As above, in a case where the transform coefficient and the transform-skipping coefficient are included in the coded stream, as depicted in (i) of FIG. 16 and (d) of FIG. 17, no mosquito noise is generated in the decoding, and impulse and gradation can be reproduced. In other words, acquisition of a decoded image having high image quality is enabled by including the transform coefficient and the transform-skipping coefficient in the coded stream compared to a case where one of the transform coefficient or the transform-skipping coefficient is included in the coded stream.

Moreover, as is clear from FIG. 16 and FIG. 17, in a case where only the transform-skipping coefficient is included in the coded stream, the image reproducibility for the low-frequency component is degraded in the decoded image. Therefore, in a case where the transform coefficient and the transform-skipping coefficient are included in the coded stream, for example, the direct current component (only the DC component) of the transform coefficient may be included in the coded stream to prevent degradation of the image reproducibility of the low-frequency component in the decoded image and to reduce the code amount.

### 5. Regarding Syntaxes Relating to Transmission of Plurality of Types of Coefficients

Because the transform coefficient and the transform-skipping coefficient are included in the coded stream in the first to the fourth embodiments of the above image coding apparatus, syntaxes to include the transform coefficient and the transform-skipping coefficient in the coded stream will next be described.

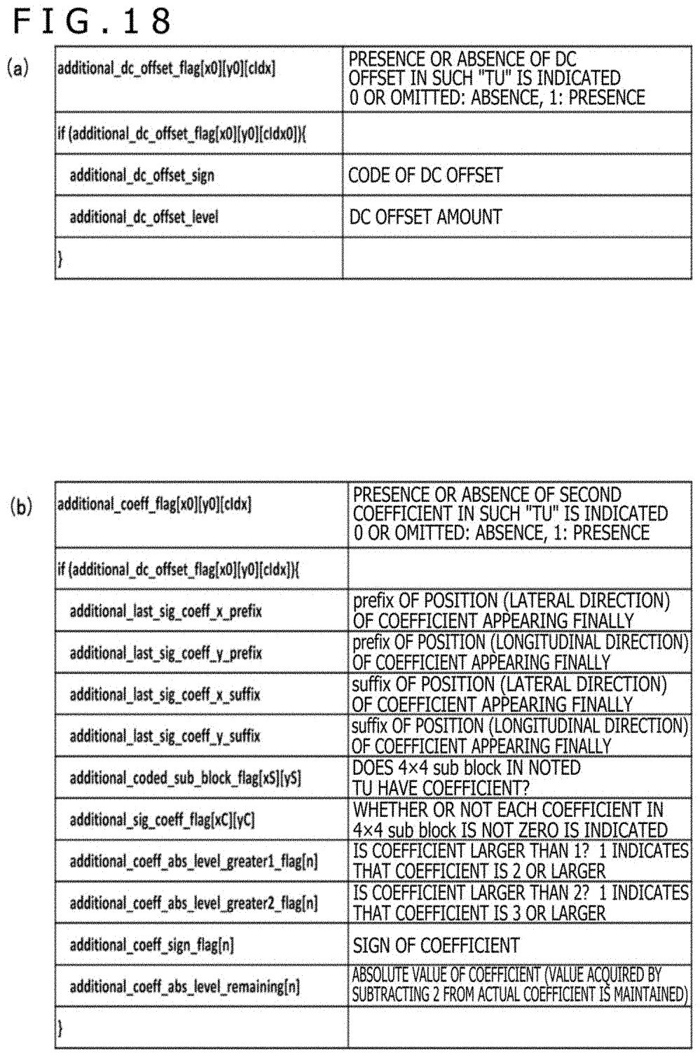

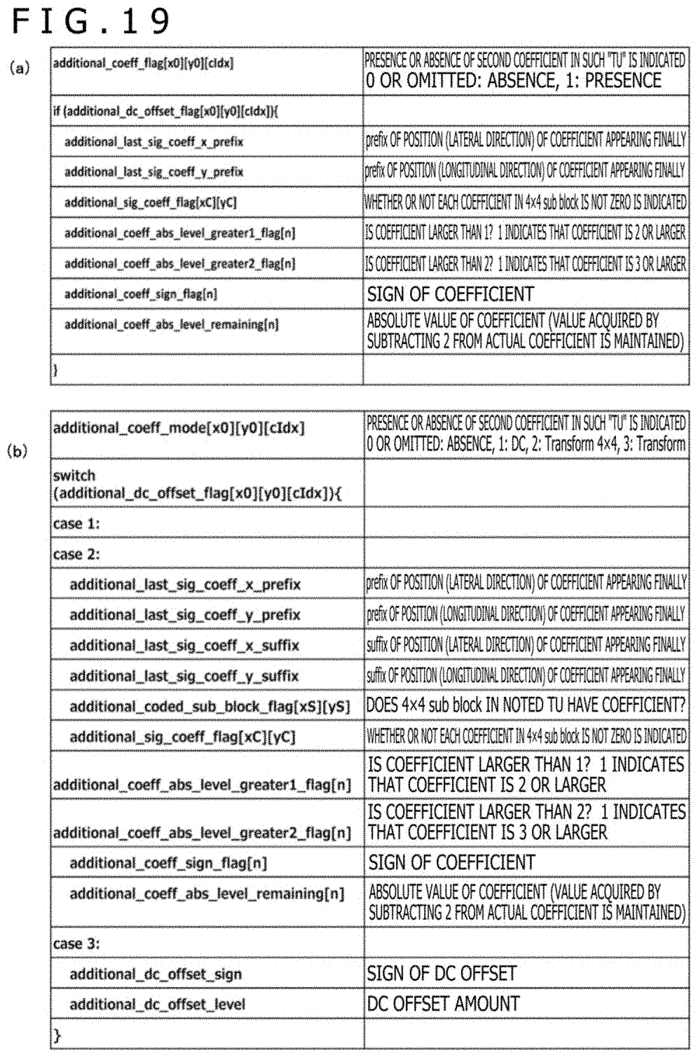

FIG. 18 and FIG. 19 exemplify the syntaxes relating to the transmission of a plurality of types of coefficients. (a) of FIG. 18 exemplifies syntaxes of a first example in the transmission of the coefficients. Note that, in the first example, the syntax is exemplified for the case where a first coefficient is used as a transform-skipping coefficient and a second coefficient is used as a direct current component (a DC component) of a transform coefficient.

“additional_dc_offset_flag[x0][y0][cIdx]” represents addition of a flag that indicates whether or not such a TU includes the DC component, the flag is set to be “0” in a case where the DC component is not included, and the flag is set to be “1” in a case where the DC component is included. “additional_dc_offset_sign” represents the sign of the DC component, and “additional_dc_offset_level” represents the value of the DC component.

(b) of FIG. 18 exemplifies syntaxes of a second example in the transmission of the coefficients. Note that, in the second example, the syntaxes are exemplified in a case where the second coefficient to be transmitted has the TU size.

“additional_coeff_flag[x0][y0][cIdx]” represents any addition of a flag that indicates whether or not such TU includes a second coefficient, the flag is set to be “0” in a case where the second coefficient is not included, and the flag is set to be “1” in a case where the second coefficient is included. “additional_last_sig_coeff_x_prefix, additional_last_sig_coeff_y_prefix, additional_last_sig_coeff_x_suffix, additional_last_sig_coeff_y_suffix” represents a prefix and a suffix of the coefficient position relating to the second coefficient.

“additional_coded_sub_block_flag[xS][yS]” is a flag that indicates whether or not non-zero coefficient is present in a 4×4-unit sub-block. “additional_sig_coeff_flag[xC][yC]” is a flag that indicates whether or not non-zero coefficient is present as each of the coefficients in the 4×4-unit sub-block.

“additional_coeff_abs_level_greater1_flag[n]” is a flag that indicates whether or not the absolute value of the coefficient is equal to or greater than 2. “additional_coeff_abs_level_greater2_flag[n]” is a flag that indicates whether or not the absolute value of the coefficient is equal to or greater than 3. “additional_coeff_sign_flag[n]” is a flag that indicates a positive or a negative sign of the coefficient. “additional_coeff_abs_level_remaining[n]” represents a value acquired by subtracting the value indicated by the flag from the absolute value of the coefficient.

(a) of FIG. 19 exemplifies syntaxes of a third example in the transmission of the coefficients. Note that, in the third example, the syntaxes are exemplified for the case where the second coefficient to be transmitted has a 4×4 size in the low band.

“additional_coeff_flag[x0][y0][cIdx]” represents addition of a flag that indicates whether or not such TU includes the second coefficient, the flag is set to be “0” in a case where the second coefficient is not included, and the flag is set to be “1” in a case where the second coefficient is included.

“additional_last_sig_coeff_x_prefix, additional_last_sig_coeff_y_prefix” represents the prefix of the coefficient position relating to the second coefficient. “additional_sig_coeff_flag[xC][yC]” is a flag that indicates whether or not non-zero coefficient is present as each of the coefficients in the 4×4-unit sub-block.

“additional_coeff_abs_level_greater1_flag[n]” is a flag that indicates whether or not the absolute value of the coefficient is equal to or greater than 2. “additional_coeff_abs_level_greater2 flag[n]” is a flag that indicates whether or not the absolute value of the coefficient is equal to or greater than 3. “additional_coeff_sign_flag[n]” is a flag that indicates the positive or the negative sign of the coefficient. “additional_coeff_abs_level_remaining[n]” represents the value acquired by subtracting the value indicated by the flag from the absolute value of the coefficient.

(b) of FIG. 19 exemplifies syntaxes of a fourth example in the transmission of the coefficients. Note that, in the fourth example, the syntaxes are exemplified in a case where any of the first to the third examples is selectable.

“additional_coeff_mode[x0][y0][cIdx]” represents any addition of a flag that indicates whether or not such TU includes the second coefficient and that also indicates the transmission mode, the flag is set to be “0” in a case where the second coefficient is not included, the flag is set to be “1” in a case where the second coefficient to be transmitted is the DC component, the flag is set to be “2” in a case where only the coefficient of 4×4 size in the low band is transmitted for the second coefficient, and the flag is set to be “3” in a case where the second coefficient to be transmitted has the TU size.

“additional_last_sig_coeff_x_prefix, additional_last_sig_coeff_prefix, additional_last_sig_coeff_x_suffix, additional_last_sig_coeff_y_suffix” represents the prefix and the suffix of the coefficient position relating to the second coefficient.

“additional_coded_sub_block_flag[xS][yS]” is a flag that indicates whether or not non-zero coefficient is present in the 4×4-unit sub-block. “additional_sig_coeff_flag[xC][yC]” is a flag that indicates whether or not non-zero coefficient is present as each of the coefficients in the 4×4-unit sub-block.

“additional_coeff_abs_level_greater1_flag[n]” is a flag that indicates whether or not the absolute value of the coefficient is equal to or greater than 2. “additional_coeff_abs_level_greater2 flag[n]” is a flag that indicates whether or not the absolute value of the coefficient is equal to or greater than 3. “additional_coeff_sign_flag[n]” is a flag that indicates the positive or the negative sign of the coefficient. “additional_coeff_abs_level_remaining[n]” represents the value acquired by subtracting the value indicated by the flag from the absolute value of the coefficient. “additional_dc_offset_sign” represents the sign of the DC component, and “additional_dc_offset_level” represents the value of the DC component.

The image coding apparatus can include the second coefficient in the coded stream by using these syntaxes, and the image decoding apparatus can suppress image quality degradation of the decoded image by executing the decoding process using the second coefficient on the basis of the syntaxy compared to a case where any one of the transform coefficient or the transform-skipping coefficient is transmitted.

<6. Regarding Quantization Parameters in Case where Plurality of Types of Coefficients is Transmitted>

Meanwhile, in the image coding apparatus, the setting of the quantization step is executed in accordance with a quantization parameter (QP) and the step width is increased as the quantization parameter is increased. Concerning this, in a case where the plurality of types of coefficients is quantized to be included in the coded stream as in the above embodiments, a quantization parameter may be set for each of the types not limiting to a case where an equal quantization parameters are used for the types of coefficients. In a case where the coded stream is produced placing importance on, for example, any one of the coefficients, the step width of the quantization step is reduced by reducing the value of the quantization parameter for the coefficient with importance and the data amount of the coefficient with importance is increased. In this manner, when the quantization parameter is set for each of the types, a coding process with a high degree of freedom is enabled, and the decoded image is enabled to have high image quality compared to the case where the equal quantization parameters are used.

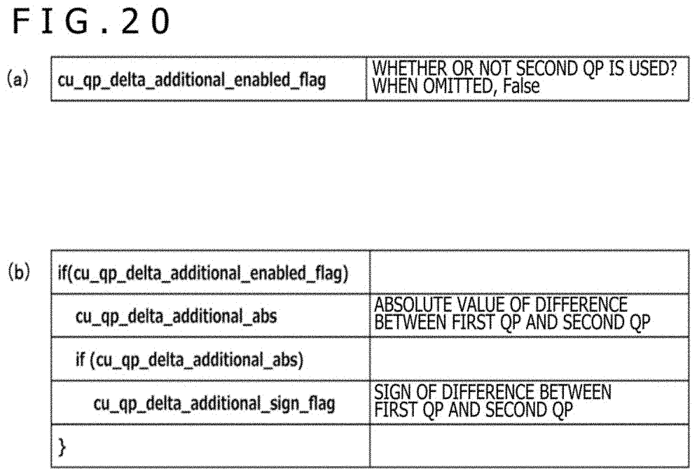

FIG. 20 exemplifies syntaxes in a case where a plurality of quantization parameters is used. In a case where a syntax of, for example, the HEVC is used, “cu_qp_delta_additional_enabled_flag” depicted in (a) of FIG. 20 is disposed in “Pic_parameter_set_rbsp.” This syntax is a flag that indicates whether or not the second quantization parameter is used.

Moreover, “cu_qp_delta_additional_abs” and “cu_qp_delta_additional_sign_flag” depicted in (b) of FIG. 20 are disposed in “transform_unit.” “cu_qp_delta_additional_abs” represents the absolute value of the difference between the first quantization parameter and the second quantization parameter, and “cu_qp_delta_additional_sign_flag” represents the positive or the negative sign of the difference between the first quantization parameter and the second quantization parameter. In a case where, for example, the first quantization parameter is set to be the quantization parameter for the coefficient of the transform skipping, the second quantization parameter is set to be the quantization parameter for the coefficient of the orthogonal transform in a case where the transform coefficient of the orthogonal transform is additionally included in the coded stream. Moreover, in a case where the first quantization parameter is set to be the quantization parameter for the transform coefficient of the orthogonal transform, the second quantization parameter is set to be the quantization parameter for the transform-skipping coefficient in a case where the transform-skipping coefficient is additionally transmitted.

The decoding process corresponding to the coding process can be executed by using these syntaxes even when the quantization parameters are individually set in including the plurality of types of coefficients in the coded stream.

In addition, a case where the transform coefficient acquired by executing the orthogonal transform and the transform-skipping coefficient acquired by executing the transform skipping process for the orthogonal transform to be skipped are included in the coded stream has been described in the above embodiments while the plurality of types of coefficients is not limited to the transform coefficient and the transform-skipping coefficient of the orthogonal transform, other transform coefficients may be used, and other coefficients may further be included.

### 7. Application Examples

Application examples of the image processing apparatus of the present technique will next be described.

### First Application Example: Television Receiver

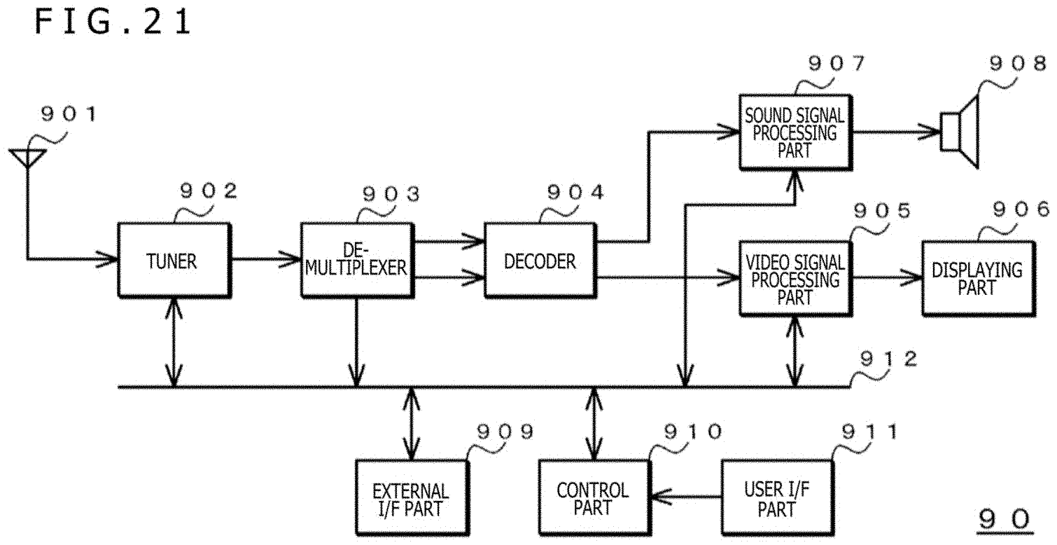

FIG. 21 depicts an example of a schematic configuration of a television apparatus to which the above image processing apparatus is applied. A television apparatus 900 includes an antenna 901, a tuner 902, a de-multiplexer 903, a decoder 904, a video signal processing part 905, a displaying part 906, a sound signal processing part 907, a speaker 908, an external interface 909, a control part 910, a user interface 911, and a bus 912.

The tuner 902 extracts a signal of a desired channel from a broadcast signal received thereby through the antenna 901, and demodulates the extracted signal. The tuner 902 next outputs a coded bit stream acquired by the demodulation to the de-multiplexer 903. In other words, the tuner 902 plays the role as the transmission means in the television apparatus 900, that receives a coded stream having images coded.

The de-multiplexer 903 separates a video stream and a sound stream of the program to be viewed from the coded bit stream, and outputs the separated streams to the decoder 904. Moreover, the de-multiplexer 903 extracts auxiliary data such as EPG (Electronic Program Guide) and the like from the coded bit stream, and outputs the extracted data to the control part 910. Note that the de-multiplexer 903 may execute descrambling in a case where the coded bit stream is scrambled.

The decoder 904 decodes the video stream and the sound stream input thereto from the de-multiplexer 903. The decoder 904 next outputs video data produced by the decoding process to the video signal processing part 905. Moreover, the decoder 904 outputs the sound data produced by the decoding process to the sound signal processing part 907.

The video signal processing part 905 reproduces the video data input from the decoder 904 and causes the displaying part 906 to display thereon a video image. Moreover, the video signal processing part 905 may cause the displaying part 906 to display thereon an application screen supplied thereto through a network. Moreover, for the video data, the video signal processing part 905 may execute additional processes such as, for example, noise removal (suppression) in accordance with the setting. Furthermore, the video signal processing part 905 may produce an image of a GUI (Graphical User Interface) such as, for example, a menu, a button, or a cursor, and may superimpose the produced image on the output image.

The displaying part 906 is driven by a driving signal supplied from the video signal processing part 905 and displays a video image or an image on a video image plane of a displaying device (such as, for example, a liquid crystal display, a plasma display, or an OELD (Organic Electroluminescence Display) (organic EL display) or the like).

The sound signal processing part 907 executes reproduction processes such as D/A conversion and amplification for the sound data input from the decoder 904, and causes the speaker 908 to output a sound. Moreover, the sound signal processing part 907 may execute additional processes such as noise removal (suppression) for the sound data.

The external interface 909 is an interface to connect the television apparatus 900 and an external device or a network to each other. For example, a video stream or a sound stream received through the external interface 909 may be decoded by the decoder 904. In other words, the external interface 909 also plays the role as the transmission means in the television apparatus 900, that receives the coded stream having the images coded.

The control part 910 includes a processor such as a CPU, and a memory such as a RAM and a ROM. The memory stores therein programs to be executed by the CPU, program data, EPG data, data acquired through the network, and the like. The programs stored by the memory are read by the CPU when, for example, the television apparatus 900 is started up, and are executed thereby. The CPU executes the programs and thereby controls the operations of the television apparatus 900 in accordance with, for example, an operation signal input thereinto from the user interface 911.

The user interface 911 is connected to the control part 910. The user interface 911 includes, for example, buttons and switches for a user to operate the television apparatus 900, a receiving part for a remote control signal, and the like. The user interface 911 detects operation by the user through these constituent elements to produce an operation signal, and outputs the produced operation signal to the control part 910.

The bus 912 mutually connects the tuner 902, the de-multiplexer 903, the decoder 904, the video signal processing part 905, the sound signal processing part 907, the external interface 909, and the control part 910 to each other.

In the television apparatus 900 configured as above, the decoder 904 has the function of the above image decoding apparatus. A decoded image with degradation in image quality suppressed can thereby be displayed when an image is decoded by the television apparatus 900.

### Second Application Example: Mobile Phone

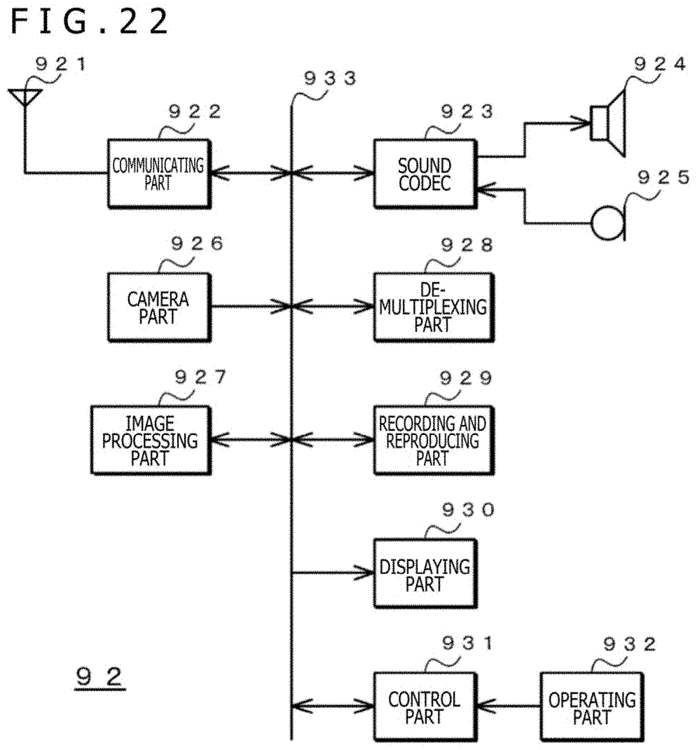

FIG. 22 depicts an example of a schematic configuration of a mobile phone to which the above embodiments are applied. A mobile phone 920 includes an antenna 921, a communicating part 922, a sound codec 923, a speaker 924, a microphone 925, a camera part 926, an image processing part 927, a multiplexing and separating part 928, a recording and reproducing part 929, a displaying part 930, a control part 931, an operational part 932, and a bus 933.

The antenna 921 is connected to the communicating part 922. The speaker 924 and the microphone 925 are connected to the sound codec 923. The operational part 932 is connected to the control part 931. The bus 933 mutually connects the communicating part 922, the sound codec 923, the camera part 926, the image processing part 927, the multiplexing and separating part 928, the recording and reproducing part 929, the displaying part 930, and the control part 931 to each other.

The mobile phone 920 executes operations such as transmission and reception of sound signals, transmission and reception of electronic mails or image data, capturing of images, and recording of data in various operation modes including a sound speech mode, a data communication mode, a capturing mode, and a television phone mode.

In the sound speech mode, an analog sound signal produced by the microphone 925 is output to the sound codec 923. The sound codec 923 converts the analog sound signal into sound data, and A/D-converts and compresses the converted sound data. The sound codec 923 next outputs the sound data after the compression to the communicating part 922. The communicating part 922 codes and modulates the sound data to produce a transmission signal. The communicating part 922 next transmits the produced transmission signal to a base station (not depicted) through the antenna 921. Moreover, the communicating part 922 amplifies and frequency-converts a wireless signal received through the antenna 921 to acquire a reception signal. The communicating part 922 next demodulates and decodes the reception signal to produce sound data, and outputs the produced sound data to the sound codec 923. The sound codec 923 expands and D/A-converts the sound data to produce an analog sound signal. The sound codec 923 next supplies the produced sound signal to the speaker 924 and causes the speaker 924 to output a sound.

Moreover, in the data communication mode, for example, the control part 931 produces character data that constitutes an electronic mail in accordance with an operation by the user through the operational part 932. Moreover, the control part 931 causes the displaying part 930 to display thereon characters. Moreover, the control part 931 produces electronic mail data in accordance with a transmission instruction from the user through the operational part 932, and outputs the produced electronic mail data to the communicating part 922. The communicating part 922 codes and modulates the electronic mail data to produce a transmission signal. The communicating part 922 next transmits the produced transmission signal to a base station (not depicted) through the antenna 921. Moreover, the communicating part 922 amplifies and frequency-converts a wireless signal received through the antenna 921 to acquire a reception signal. The communicating part 922 next demodulates and decodes the reception signal to restore electronic mail data, and outputs the restored electronic mail data to the control part 931. The control part 931 causes the displaying part 930 to display thereon the content of the electronic mail, and causes a storage medium of the recording and reproducing part 929 to store therein the electronic mail data.

The recording and reproducing part 929 includes an optional readable and writable storage medium. For example, the storage medium may be an incorporated storage medium such as a RAM or a flash memory or may be an externally attached storage medium such as a hard disk, a magnetic disk, a magneto-optical disk, an optical disk, a USB (Universal Serial Bus) memory, or a memory card.

Moreover, in the capturing mode, for example, the camera part 926 images an object to produce image data, and outputs the produced image data to the image processing part 927. The image processing part 927 codes the image data input from the camera part 926 and causes the storage medium of the recording and reproducing part 929 to store therein the coded stream.

Moreover, in the television phone mode, for example, the multiplexing and separating part 928 multiplexes the video stream coded by the image processing part 927 and the sound stream input thereinto from the sound codec 823 with each other, and outputs the multiplexed stream to the communicating part 922. The communicating part 922 codes and modulates the stream to produce a transmission signal. The communicating part 922 next transmits the produced transmission signal to a base station (not depicted) through the antenna 921. Moreover, the communicating part 922 amplifies and frequency-converts a wireless signal received thereby through the antenna 921 to acquire a reception signal. The transmission signal and the reception signal may each include a coded stream. The communicating part 922 next demodulates and decodes the reception signal to restore the stream, and outputs the restored stream to the multiplexing and separating part 928. The multiplexing and separating part 928 separates the video stream and the sound stream from the input stream, and outputs the video stream to the image processing part 927 and outputs the sound stream to the sound codec 923. The image processing part 927 decodes the video stream to produce video data. The video data is supplied to the displaying part 930 and a series of images is displayed by the displaying part 930. The sound codec 923 expands and D/A-converts the sound stream to produce an analog sound signal. The sound codec 923 next supplies the produced sound signal to the speaker 924 and causes the speaker 924 to output a sound.

In the mobile phone 920 configured as above, the image processing part 927 has the functions of the above image coding apparatus and the above image decoding apparatus. Improvement of the coding efficiency and output of a decoded image with degradation in image quality suppressed are thereby enabled in the coding and the decoding of the image by the mobile phone 920.

### Third Application Example: Recording and Reproducing Apparatus

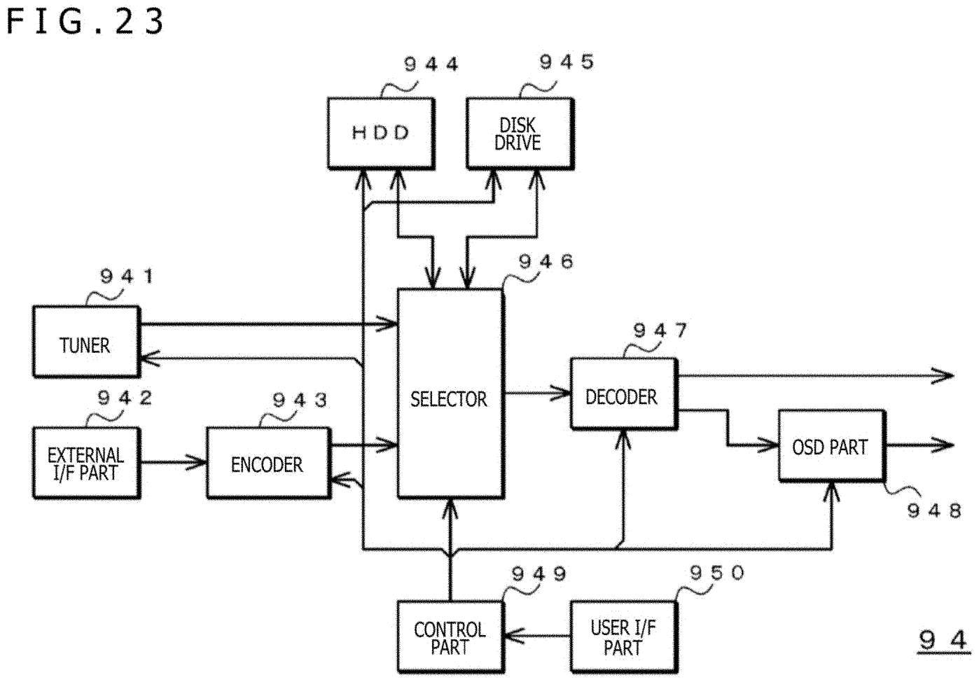

FIG. 23 depicts an example of a schematic configuration of a recording and reproducing apparatus to which the above embodiments are applied. The recording and reproducing apparatus 940 codes, for example, sound data and video data of a received broadcasted program and records the coding result on a recording medium. Moreover, the recording and reproducing apparatus 940 may also code, for example, sound data and video data that are acquired from another apparatus and may record the coding result on the recording medium. Moreover, the recording and reproducing apparatus 940 reproduces the data recorded on the recording medium on the monitor and the speaker in accordance with, for example, an instruction by the user. At this time, the recording and reproducing apparatus 940 decodes the sound data and the video data.

The recording and reproducing apparatus 940 includes a tuner 941, an external interface 942, an encoder 943, an HDD (Hard Disk Drive) 944, a disk drive 945, a selector 946, a decoder 947, an OSD (On-Screen Display) 948, a control part 949, and a user interface 950.

The tuner 941 extracts a signal of a desired channel from a broadcast signal received through an antenna (not depicted) and demodulates the extracted signal. The tuner 941 next outputs a coded bit stream acquired by the demodulation to the selector 946. In other words, the tuner 941 plays the role as the transmission means in the recording and reproducing apparatus 940.

The external interface 942 is an interface to connect the recording and reproducing apparatus 940, and an external device or a network to each other. The external interface 942 may be, for example, an IEEE 1394 interface, a network interface, a USB interface, a flash memory interface, or the like. For example, the video data and the sound data received through the external interface 942 are input into the encoder 943. In other words, the external interface 942 plays the role as the transmission means in the recording and reproducing apparatus 940.

In a case where the video data and the sound data input from the external interface 942 are not coded, the encoder 943 codes the video data and the sound data. The encoder 943 next outputs the coded bit stream to the selector 946.

The HDD 944 records a coded bit stream formed by compressing content data such as a video image and a sound, various types of programs, and other pieces of data, on a hard disk included therein. Moreover, the HDD 944 reads these pieces of data from the hard disk when the video image and the sound are reproduced.

The disk drive 945 executes recording and reading of data to/from a recording medium attached thereto. The recording medium attached to the disk drive 945 may be, for example, a DVD disc (such as a DVD-video, a DVD-RAM, a DVD-R, a DVD-RW, a DVD+R, or a DVD+RW), a Blu-ray (a registered trademark) disc, or the like.

When a video image and a sound are recorded, the selector 946 selects the coded bit stream input from the tuner 941 or the encoder 943, and outputs the selected coded bit stream to the HDD 944 or the disk drive 945. Moreover, when the video image and the sound are reproduced, the selector 946 outputs the coded bit stream input from the HDD 944 or the disk drive 945 to the decoder 947.

The decoder 947 decodes the coded bit stream to produce the video data and the sound data. The decoder 947 next outputs the produced video data to the OSD 948. Moreover, the decoder 904 outputs the produced sound data to an external speaker.

The OSD 948 reproduces the video data input from the decoder 947, and displays thereon the video image. Moreover, the OSD 948 may superimpose an image of GUI such as, for example, a menu, a button, or a cursor on the video image to be displayed thereon.

The control part 949 includes a processor such as a CPU, and a memory such as a RAM and a ROM. The memory stores therein programs to be executed by the CPU, program data, and the like. The programs stored by the memory are read by the CPU when, for example, the recording and reproducing apparatus 940 is started up, and are executed. The CPU executes the programs and thereby controls the operations of the recording and reproducing apparatus 940 in accordance with, for example, an operation signal input from the user interface 950.

The user interface 950 is connected to the control part 949. The user interface 950 includes buttons and switches for the user to operate the recording and reproducing apparatus 940 and a receiving part for a remote control signal. The user interface 950 detects an operation by the user through these constituent elements to produce an operation signal, and outputs the produced operation signal to the control part 949.

In the recording and reproducing apparatus 940 configured as above, the encoder 943 has the function of the above image coding apparatus. Moreover, the decoder 947 has the function of the above image decoding apparatus. Thereby, the coding efficiency can be improved and reproduction of a decoded image with degradation in image quality suppressed can be executed in the coding and decoding of an image by the recording and reproducing apparatus 940.

### Fourth Application Example: Imaging Apparatus

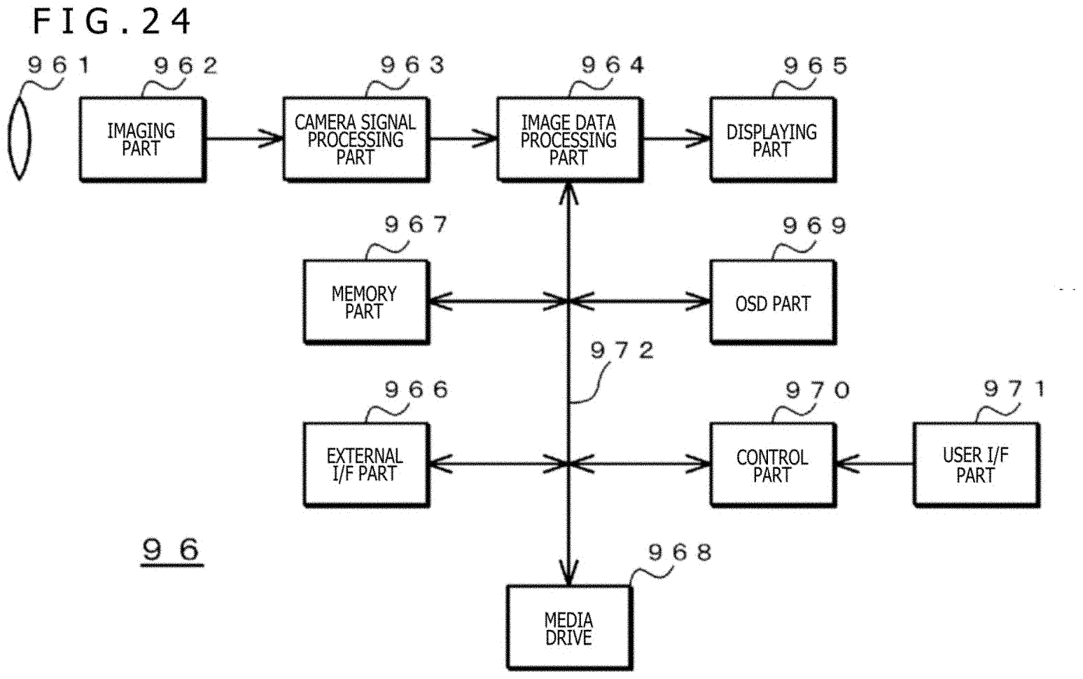

FIG. 24 depicts an example of a schematic configuration of an imaging apparatus to which the above embodiments are applied. The imaging apparatus 960 images an object to produce an image, codes the image data, and records the coded image data in a recording medium.

The imaging apparatus 960 includes an optical block 961, an imaging part 962, a signal processing part 963, an image processing part 964, a displaying part 965, an external interface 966, a memory 967, a media drive 968, an OSD 969, a control part 970, a user interface 971, and a bus 972.

The optical block 961 is connected to the imaging part 962. The imaging part 962 is connected to the signal processing part 963. The displaying part 965 is connected to the image processing part 964. The user interface 971 is connected to the control part 970. The bus 972 mutually connects the image processing part 964, the external interface 966, the memory 967, the media drive 968, the OSD 969, and the control part 970 to each other.

The optical block 961 includes a focusing lens, a diaphragm mechanism, and the like. The optical block 961 provides an optical image of an object onto an imaging plane of the imaging part 962. The imaging part 962 includes an image sensor such as a CCD (Charge Coupled Device) or a CMOS (Complementary Metal Oxide Semiconductor), and converts the optical image provided on the imaging plane into an image signal as an electric signal by photoelectric conversion. The imaging part 962 next outputs the image signal to the signal processing part 963.

The signal processing part 963 executes various types of camera signal processing for the image signal input from the imaging part 962, such as knee correction, gamma correction, and color correction. The signal processing part 963 outputs the image data after the camera signal processing to the image processing part 964.

The image processing part 964 codes the image data input from the signal processing part 963 to produce coded data. The image processing part 964 next outputs the produced coded data to the external interface 966 or the media drive 968. Moreover, the image processing part 964 decodes the coded data input from the external interface 966 or the media drive 968 to produce image data. The image processing part 964 next outputs the produced image data to the displaying part 965. Moreover, the image processing part 964 may output the image data input from the signal processing part 963, to the displaying part 965 to cause the displaying part 965 to display thereon an image. Moreover, the image processing part 964 may superimpose data to be displayed that is acquired from the OSD 969 on the image to be output to the displaying part 965.

The OSD 969 produces an image of the GUI such as, for example, a menu, a button, or a cursor and outputs the produced image to the image processing part 964.

The external interface 966 is constituted as, for example, a USB input terminal. The external interface 966 connects the imaging apparatus 960 and a printer to each other when an image is printed, for example. Moreover, to the external interface 966, a drive is connected when necessary. A removable medium such as, for example, a magnetic disk or an optical disk may be attached to the drive and programs read from the removable medium may be installed in the imaging apparatus 960. Furthermore, the external interface 966 may be constituted as a network interface connected to a network such as a LAN or the Internet. In other words, the external interface 966 plays the role as the transmission means in the imaging apparatus 960.

The recording medium to be attached to the media drive 968 may be, for example, an optional readable and writable removable medium such as a magnetic disk, a magneto-optical disk, an optical disk, or a semiconductor memory. Moreover, a recording medium may be fixedly attached to the media drive 968, and a non-portable storage part may thereby be constituted like, for example, an incorporated hard disk drive, or an SSD (Solid State Drive).

The control part 970 includes a processor such as a CPU and a memory such as a RAM and a ROM. The memory stores therein programs to be executed by the CPU, program data, and the like. The programs stored by the memory are read by the CPU when the imaging apparatus 960 is started up and are executed. The CPU executes the programs and thereby controls the operations of the imaging apparatus 960 in accordance with, for example, an operation signal input from the user interface 971.

The user interface 971 is connected to the control part 970. The user interface 971 includes, for example, buttons, switches, and the like for the user to operate the imaging apparatus 960. The user interface 971 detects an operation by the user through these constituent elements to produce an operation signal, and outputs the produced operation signal to the control part 970.

In the imaging apparatus 960 configured as above, the image processing part 964 has the functions of the image coding apparatus and the image decoding apparatus according to the above embodiments. Improvement of the coding efficiency and output of a decoded image with degradation in image quality suppressed are thereby enabled in the coding and the decoding of the image by the imaging apparatus 960.

The series of processes described herein can be executed by hardware, software, or a composite configuration of these. In a case where processes by software are executed, a program having the processing sequence recorded therein is installed in a memory in a computer incorporated in dedicated hardware and the computer is caused to execute the program. Alternatively, the program can be installed in a general-purpose computer capable of executing various types of processing and the computer can be caused to execute the program.

For example, the program can be recorded in advance on a hard disk, an SSD (Solid State Drive), and a ROM (Read Only Memory) each as a recording medium. Alternatively, the program can be stored (recorded) temporarily or permanently in a removable recording medium such as a flexible disk, a CD-ROM (Compact Disc Read Only Memory), an MO (Magnetic optical) disk, a DVD (Digital Versatile Disc), a BD (Blu-Ray Disc (registered trademark)), a magnetic disk, or a semiconductor memory card. The removable recording medium can be provided as what-is-called packaged software.

Moreover, in addition to installing the program from the removable recording medium to a computer, the program may be transferred by wireless or by wire to a computer through a network such as a LAN (Local Area Network) or the Internet from a download site. The computer can receive the program transferred as above, and can install the program into a recoding medium such as an incorporated hard disk or the like.

Note that the effects described herein are merely exemplification and are not limited, and any additional effects not described may be achieved. Moreover, the present technique should not be interpreted being limited to the above embodiments of the technique. The embodiments of the present technique disclose the present technique in the form of exemplification, and it is obvious that those skilled in the art can make modification and substitution to the embodiments within the scope not departing from the gist of the present technique. In other words, the claims should be taken into account in understanding the gist of the present technique.

Moreover, the image processing apparatus of the present technique can also take the following configurations.

(1) An image processing apparatus including:

a quantizing part quantizing a plurality of types of coefficients that is produced by respective transform processing blocks from image data, for each of the types, to produce quantized data; and

a coding part coding the quantized data of each of the plurality of types produced by the quantizing part, to produce a coded stream.

(2) The image processing apparatus according to (1), in which

the plurality of types of coefficients includes a transform coefficient acquired by executing an orthogonal transform and a transform-skipping coefficient acquired by executing a transform-skipping process that skips the orthogonal transform.

(3) The image processing apparatus according to (2), in which

the coding part codes

quantized data of the transform coefficient acquired by executing the orthogonal transform for the image data, and

quantized data of the transform-skipping coefficient acquired by executing the transform-skipping process for the image data.

(4) The image processing apparatus according to (3), in which

the quantized data of the transform coefficient indicates a direct current component of the transform coefficient.

(5) The image processing apparatus according to (3), further including

a filtering part executing a component separation process for the image data, in which

the coding part codes

quantized data of a transform coefficient acquired by executing the orthogonal transform for first separation data acquired by the component separation process by the filtering part, and

quantized data of a transform-skipping coefficient acquired by executing the transform-skipping process for second separation data different from the first separation data that is acquired by the component separation process by the filtering part.

(6) The image processing apparatus according to (5), in which

the filtering part executes a component separation process in a frequency region to produce the first separation data and the second separation data that includes a frequency component higher than the first separation data.

(7) The image processing apparatus according to (5), in which

the filtering part executes a component separation process in a spatial region to produce the first separation data and the second separation data by a computation process that uses a smoothing process and a texture component extraction process, or either the smoothing process or the texture component extraction process, and a process result.

(8) The image processing apparatus according to (7), in which

the filtering part produces the first separation data by the smoothing process, or by a computation process that uses a process result of the texture component extracting process and the image data, and produces the second separation data by the texture component extraction process or by a computation process that uses a process result of the smoothing process and the image data.

(9) The image processing apparatus according to (2), in which

the coding part codes

quantized data of a transform coefficient acquired by executing the orthogonal transform for the image data, and

quantized data of a transform-skipping coefficient acquired by executing the transform-skipping process for a difference between decoded data acquired by executing quantization, inverse quantization, and inverse orthogonal transform of the transform coefficient, and the image data.

(10) The image processing apparatus according to (2), in which

the coding part codes

quantized data of a transform-skipping coefficient acquired by executing the transform-skipping process for the image data, and

quantized data of a transform coefficient acquired by executing the orthogonal transform for a difference between decoded data acquired by executing quantization and inverse quantization of the transform-skipping coefficient, and the image data.

(11) The image processing apparatus according to any of (1) to (10), in which

the quantizing part executes quantization of the coefficients on a basis of a quantized parameter set for each of the types of the coefficients, and

the coding part codes information indicating a quantized parameter set for each of the types of the coefficients and includes the coded information in the coded stream.

(12) The image processing apparatus according to any of (1) to (11), in which

the image data includes residual data that indicates a difference between image data to be coded and predicted image data.

Furthermore, the image processing apparatus of the present technique can also take the following configurations.

(1) An image processing apparatus including:

a decoding part executing decoding for a coded stream to acquire quantized data of a plurality of types of coefficients, for each of the types;

an inverse-quantizing part executing inverse quantization for the quantized data acquired by the decoding part to produce each of the types of coefficients;

an inverse-transforming part producing image data for each of the types of the coefficients from the coefficients acquired by the inverse-quantizing part; and

a computing part executing a computation process using the image data of each of the types of the coefficients acquired by the inverse-transforming part to produce decoded image data.

(2) The image processing apparatus according to (1), in which

the decoding part executes decoding for the coded stream to acquire information that indicates quantized parameters of the plurality of types of coefficients for each of the types, and

the inverse-quantizing part executes inverse quantization of corresponding quantized data using information regarding corresponding quantized parameter for each of the types of the coefficients.

(3) The image processing apparatus according to (1) or (2), in which

the computing part adds image data and predicted image data to each other for each of the types of the coefficients acquired by the inverse-transforming part, aligning each pixel position, to produce the decoded image data.

### INDUSTRIAL APPLICABILITY

According to the image processing apparatus, the image processing method, and the program of the present technique, the plurality of types of coefficients produced by the respective transform processing blocks from the image data is quantized for each of the types to produce the quantized data, and the quantized data of each of the plurality of types is coded to produce the coded stream. Moreover, decoding is executed for the coded stream to acquire the quantized data for each of the types of the plurality of types of coefficients, and inverse quantization is executed for the acquired quantized data to produce the coefficient for each of the types. Moreover, the image data is produced for each of the types of the coefficients from the produced coefficients to produce the decoded image data by the computation process using the image data for each of the types of the coefficients. Degradation in image quality of the decoded image can therefore be suppressed. The present technique is therefore suitable for electronic equipment that executes a coding process or a decoding process for image data.

### REFERENCE SIGNS LIST

10-1, 10-2, 10-3, 10-4 . . . Image coding apparatus
11, 70 . . . Screen sorting buffer
12, 19, 24, 34, 36, 39, 41, 68, 137 . . . Computing part
13 . . . Filtering part
14, 26, 131 . . . Orthogonal transforming part
15, 16, 17, 25, 27 . . . Quantizing part
17, 18, 22, 31, 33, 35, 37, 63, 67 . . . Inverse-quantizing part
23, 32, 38, 65, 133, 134 . . . Inverse-orthogonal transforming part
28 . . . Entropy coding part
29, 61 . . . Accumulation buffer
30 . . . Rate control part
42, 69 . . . In-loop filter
43, 71 . . . Frame memory
44, 64, 72 . . . Selecting part
45, 73 . . . Intra predicting part
46 . . . Motion predicting and compensating part
47 . . . Prediction selecting part
60-1, 60-2 . . . Image decoding apparatus
62 . . . Entropy decoding part
66 . . . Buffer
74 . . . Motion compensating part
132 . . . Frequency separating part
135, 136 . . . Spatial filter

1. An image processing apparatus comprising:
a quantizing part quantizing a plurality of types of coefficients that is produced by respective transform processing blocks from image data, for each of the types, to produce quantized data; and
a coding part coding the quantized data of each of the plurality of types produced by the quantizing part, to produce a coded stream,
wherein the plurality of types of coefficients includes a transform coefficient acquired by executing an orthogonal transform and a transform-skipping coefficient acquired by executing a transform-skipping process that skips the orthogonal transform.

2. (canceled)

3. The image processing apparatus according to claim 1, wherein
the coding part codes
quantized data of the transform coefficient acquired by executing the orthogonal transform for the image data, and
quantized data of the transform-skipping coefficient acquired by executing the transform-skipping process for the image data.

4. The image processing apparatus according to claim 3, wherein
the quantized data of the transform coefficient indicates a direct current component of the transform coefficient.

5. The image processing apparatus according to claim 3, further comprising:
a filtering part executing a component separation process for the image data, wherein
the coding part codes
quantized data of a transform coefficient acquired by executing the orthogonal transform for first separation data acquired by the component separation process by the filtering part, and
quantized data of a transform-skipping coefficient acquired by executing the transform-skipping process for second separation data different from the first separation data that is acquired by the component separation process by the filtering part.

6. The image processing apparatus according to claim 5, wherein
the filtering part executes a component separation process in a frequency region to produce the first separation data and the second separation data that includes a frequency component higher than the first separation data.

7. The image processing apparatus according to claim 5, wherein
the filtering part executes a component separation process in a spatial region to produce the first separation data and the second separation data by a computation process that uses a smoothing process and a texture component extraction process, or either the smoothing process or the texture component extraction process, and a process result.

8. The image processing apparatus according to claim 7, wherein
the filtering part produces the first separation data by the smoothing process, or by a computation process that uses a process result of the texture component extracting process and the image data, and produces the second separation data by the texture component extraction process or by a computation process that uses a process result of the smoothing process and the image data.

9. The image processing apparatus according to claim 1, wherein
the coding part codes
quantized data of a transform coefficient acquired by executing the orthogonal transform for the image data, and
quantized data of a transform-skipping coefficient acquired by executing the transform-skipping process for a difference between decoded data acquired by executing quantization, inverse quantization, and inverse orthogonal transform of the transform coefficient, and the image data.

10. The image processing apparatus according to claim 1, wherein
the coding part codes
quantized data of a transform-skipping coefficient acquired by executing the transform-skipping process for the image data, and
quantized data of a transform coefficient acquired by executing the orthogonal transform for a difference between decoded data acquired by executing quantization and inverse quantization of the transform-skipping coefficient, and the image data.

11. The image processing apparatus according to claim 1, wherein
the quantizing part executes quantization of the coefficients on a basis of a quantized parameter set for each of the types of the coefficients, and
the coding part codes information indicating a quantized parameter set for each of the types of the coefficients and includes the coded information in the coded stream.

12. The image processing apparatus according to claim 1, wherein
the image data includes residual data that indicates a difference between image data to be coded and predicted image data.

13. An image processing method comprising the steps of:
quantizing, as a plurality of types of coefficients produced by respective transform processing blocks from image data, the coefficients for each of the types by using a transform coefficient acquired by executing orthogonal transform and a transform-skipping coefficient acquired by executing a transform-skipping process that skips the orthogonal transform to thereby produce quantized data; and
producing a coded stream by coding the quantized data of each of the plurality of types produced by the quantizing part.

14. A program causing a computer to execute an image coding process, the program causing the computer to execute:
a procedure of quantizing, as a plurality of types of coefficients produced by respective transform processing blocks from image data, the coefficients for each of the types by using a transform coefficient acquired by executing orthogonal transform and a transform-skipping coefficient acquired by executing a transform-skipping process that skips the orthogonal transform to thereby produce quantized data; and
a procedure of coding the produced quantized data of each of the plurality of types to produce a coded stream.

15. An image processing apparatus comprising:
a decoding part executing decoding of a coded stream, and acquiring quantized data produced by quantizing, as a plurality of types of coefficients, the coefficients for each of the types by using a transform coefficient acquired by executing orthogonal transform and a transform-skipping coefficient acquired by executing a transform-skipping process that skips the orthogonal transform;
an inverse-quantizing part executing inverse quantization for the quantized data acquired by the decoding part to produce each of the types of coefficients;
an inverse-transforming part producing image data for each of the types of the coefficients from the coefficients acquired by the inverse-quantizing part; and
a computing part executing a computation process using the image data of each of the types of the coefficients acquired by the inverse-transforming part to produce decoded image data.

16. The image processing apparatus according to claim 15, wherein
the decoding part executes decoding for the coded stream to acquire information that indicates quantized parameters of the plurality of types of coefficients for each of the types, and
the inverse-quantizing part executes inverse quantization of corresponding quantized data using information regarding corresponding quantized parameter for each of the types of the coefficients.

17. The image processing apparatus according to claim 15, wherein
the computing part adds image data and predicted image data to each other for each of the types of the coefficients acquired by the inverse-transforming part, aligning each pixel position, to produce the decoded image data.

18. An image processing method comprising the steps of:
executing decoding of a coded stream, and acquiring quantized data produced by quantizing, as a plurality of types of coefficients, the coefficients for each of the types by using a transform coefficient acquired by executing orthogonal transform and a transform-skipping coefficient acquired by executing a transform-skipping process that skips the orthogonal transform;
executing inverse quantization of the acquired quantized data to produce each of the types of coefficients;
producing image data for each of the types of the coefficients from the produced coefficients; and
executing a computation process using the image data of each of the types of the coefficients to produce decoded image data.

19. A program causing a computer to execute an image decoding process, the program causing the computer to execute:
a procedure of executing decoding of a coded stream, and acquiring quantized data produced by quantizing, as a plurality of types of coefficients, the coefficients for each of the types by using a transform coefficient acquired by executing orthogonal transform and a transform-skipping coefficient acquired by executing a transform-skipping process that skips the orthogonal transform;
a procedure of executing an inverse quantization of the acquired quantized data to produce each of the types of coefficients;
a procedure of producing image data for each of the types of the coefficients from the produced coefficient; and
a procedure of executing a computation process using the image data of each of the types of the coefficients to produce decoded image data.
